(19) United States
(12) Patent Application Publication
(10) Pub. No.: US 2024/0333009 A1
(43) Pub. Date: Oct. 3, 2024

(54) SYNTHESIS AND ENVELOPE RECTIFICATION FOR WAVEFORMS AND THEIR HARMONICS IN A FREQUENCY SWITCHED TOPOLOGY

(71) Applicant: Iontra Inc, Centennial, CO (US)

(72) Inventors: Manoj K. KOUL, Allen, TX (US); Anthony KUSTAS, Brooklyn, NY (US); John Richard HOWLETT, III, Centennial, CO (US); William E. CHECK, Denver, CO (US); David KESSNER, Denver, CO (US)

(21) Appl. No.: 18/618,943

(22) Filed: Mar. 27, 2024

Related U.S. Application Data
(60) Provisional application No. 63/618,193, filed on Jan. 5, 2024.
(60) Provisional application No. 63/492,309, filed on Mar. 27, 2023.

(51) Int. Cl. H02J 7/00

(52) U.S. Cl. CPC H02J 7/007; H02J 7/0047

(57) ABSTRACT

Systems, circuits, and methods are disclosed for charging battery cells by generating a shaped charge signal that is shaped as controlled through a signal shaping generator. In one example, one or both of a pair of transistors may be controlled with a pulse-width modulation (PWM) signal with a duty cycle. The PWM signal is applied to the gates of the respective transistors to produce a sequence of pulses, which when applied to an inductor, produces a shaped waveform that may be applied to the battery. In an aspect, the duty cycle of the PWM controlling the operation of the transistors correlates to a charge current applied to the battery, such that a higher duty cycle of the PWM control signal results in a higher current applied to charge the battery. The signal shaping generator utilizes a target shape to begin shaping a charge signal for the battery.

### RELATED APPLICATIONS

This application claims priority under 35 U.S.C. § 119 to U.S. Patent Application No. 63/492,309 filed Mar. 27, 2023, titled “SHAPING OF A BATTERY CELL CHARGING SIGNAL USING A PULSE-WIDTH MODULATION DUTY CYCLE,” and to U.S. Patent Application No. 63/618,193 filed Jan. 5, 2024, titled “SYNTHESIS AND ENVELOPE RECTIFICATION FOR WAVEFORMS AND THEIR HARMONICS IN A FREQUENCY SWITCHED TOPOLOGY,” both of which are hereby incorporated by reference in their entirety.

### TECHNICAL FIELD

Embodiments of the present invention generally relate to systems and methods for charging of one or more battery cells, and more specifically for a generation of a tunable, high-efficiency and/or high-rate charging signal to charge one or more battery cells.

### BACKGROUND

Many electrically-powered devices, such as power tools, vacuums, any number of different portable electronic devices, and electric vehicles, use rechargeable batteries as a source of operating power. Rechargeable batteries are limited by finite battery capacity and must be recharged upon depletion. Recharging a battery may be inconvenient as the powered device must often be stationary during the time required for recharging the battery. In the case of vehicles, recharging can take hours. As such, significant effort has been put into developing rapid charging technology to reduce the time needed to recharge the battery. However, whether rapid recharging or otherwise, conventional charging techniques may damage the battery in a variety of ways resulting in decreased capacity, decreased power, and, in some situations, failure. Lower rate recharging systems may slow degradation of the battery but prolong the recharging operation, undermining the basic objective of a quick return to service.

These challenges, among others, are addressed by various aspects of the present disclosure as described in detail below.

### SUMMARY

In one aspect of this disclosure, a method is provided of charging an electrochemical device including modulating a pulse-width modulated (PWM) control signal onto a carrier signal for controlling a switching device of an electrochemical charging circuit. The method may also include controlling, with the modulated signal, a switching device of an electrochemical charging circuit; and iteratively adjusting, based on a frequency of the carrier signal and a predetermined sample rate, a number of samples of a characteristic of the electrochemical device stored in a buffer, the number of samples corresponding to obtaining a sample of the characteristic of the electrochemical device corresponding to an aspect of the modulated signal.

In another aspect of this disclosure, a battery cell charging system is provided including a charge signal shaping circuit modulating a pulse-width modulated (PWM) control signal onto a carrier signal for controlling a switching device of an electrochemical charging circuit and a controller to adjust, based on a plurality of derivatives of the modulated signal, a duty cycle of the PWM control signal of the modulated signal and control the switching device with the adjusted PWM control signal.

In yet another aspect of this disclosure, a system for generating a signal for a battery cell is provided including a microcontroller unit (MCU) comprising a memory table, wherein the memory table contains data defining a carrier waveform and wherein the carrier waveform has a carrier waveform frequency and a digital-to-analog converter (DAC) in communication with the MCU and configured to receive the data defining the carrier waveform and provide an output signal to an amplifier. The amplifier may include a plurality of switching elements configured to operate at selected switching element frequencies, the selected switching element frequencies may be higher than the carrier waveform frequency, and the selected switching element frequencies are configured to produce a stepped waveform having current steps that approximate a shape of the carrier waveform.

In still another aspect of this disclosure, a method of charging an electrochemical device is provided including the operations of initializing a duty cycle of a pulse-width modulated (PWM) control signal and controlling, with a PWM control signal, a switching device of an electrochemical charging circuit. The method may also include iteratively performing the operations of adjusting, based on a comparison of a measured characteristic of the electrochemical device to an expected characteristic of the electrochemical device, the initialized duty cycle of the PWM control signal; and controlling the switching device with the adjusted PWM control signal.

### BRIEF DESCRIPTION OF THE DRAWINGS

FIG. 1A is a signal diagram of a direct current voltage or current signal for recharging a battery cell.

FIG. 1B is a graph of estimated real impedance values of a battery cell to corresponding frequencies of a charge signal applied to the battery cell in accordance with one embodiment.

FIG. 2 is a schematic diagram illustrating a system for charging a battery cell utilizing a charge signal shaping circuit in accordance with one embodiment.

FIG. 3 is a signal graph of an example shaped charge waveform for charging a battery cell in accordance with one embodiment.

FIG. 4 is a schematic diagram illustrating a system for charging a battery cell utilizing switching elements to shape a charge signal in accordance with one embodiment.

FIGS. 5A and 5B are block diagrams illustrating components of a controller used to alter a duty cycle of a pulse-width modulated signal to shape a charge signal for a battery cell in accordance with one embodiment.

FIG. 6 is a flowchart of a method for iteratively altering a duty cycle of a pulse-width modulated signal to shape a charge signal for a battery cell in accordance with one embodiment.

FIG. 7 is a block diagram illustrating a flow of data for iteratively altering a duty cycle of a pulse-width modulated signal to shape a charge signal for a battery cell in accordance with one embodiment.

FIGS. 8A-8D are signal graphs generated from a charge signal controller through altering of a duty cycle of a pulse-width modulated signal in accordance with one embodiment.

FIG. 9 is a diagram illustrating different clock domains of the circuit for charging the battery of FIG. 4 in accordance with one embodiment.

FIG. 10 is an illustration of a carrier waveform and a sampling frequency that may be utilized by the circuit for charging a battery in accordance with one embodiment.

FIG. 11 is a flowchart of a method for determining a number of samples to store in a buffer based on a relationship between a carrier frequency and a sample rate of a battery cell charging signal.

FIGS. 12A-12D are sample waveforms for which a maxima, minima, and/or zero crossing portions may be estimated for use in generating a battery cell charging signal.

FIG. 13A is a block diagram representing a clocking scheme in accordance with embodiments described herein.

FIG. 13B is an example output signal having a complex waveform shape formed by an oscillating PWM pattern superimposed on a carrier waveform.

FIG. 14A is a block diagram of an example system that may be used to generate a complex waveform.

FIG. 14B is an example output signal having a complex waveform shape that may be produced by systems described herein.

FIG. 15 is a block diagram of an example system including a class D amplifier and feedback subsystem that may be used to generate a complex waveform.

FIG. 16 is a diagram illustrating an example of a computing system which may be used in implementing embodiments of the present disclosure.

### DETAILED DESCRIPTION

At perhaps the simplest level, battery charging involves applying a DC charge current to a battery cell. Various battery types, however, can only accept so much current before damaging the cells. Generally speaking, a battery cell may be recharged through the application of a recharging power signal from a controllable power source. Although discussed herein as applicable to a cell or a battery cell, it should be appreciated that the systems and methods described may apply to many different type of cells, as well as batteries comprising of a collection of cells coupled in parallel, series, parallel and series, e.g. For example, the systems and methods discussed herein may apply to a battery pack comprising numerous cells arranged to provide a defined pack voltage, output current, and/or capacity. In general, the application of the power signal to the electrodes of the battery cell causes a reverse flow of electrons through the battery to replenish the stored concentration of charge carriers (such as lithium ions) at the anode. In one particular example, the power source may be a direct current (DC) voltage source to provide a DC charge current to the battery cell. Other types of power sources, such as a current controlled source, may also be used.

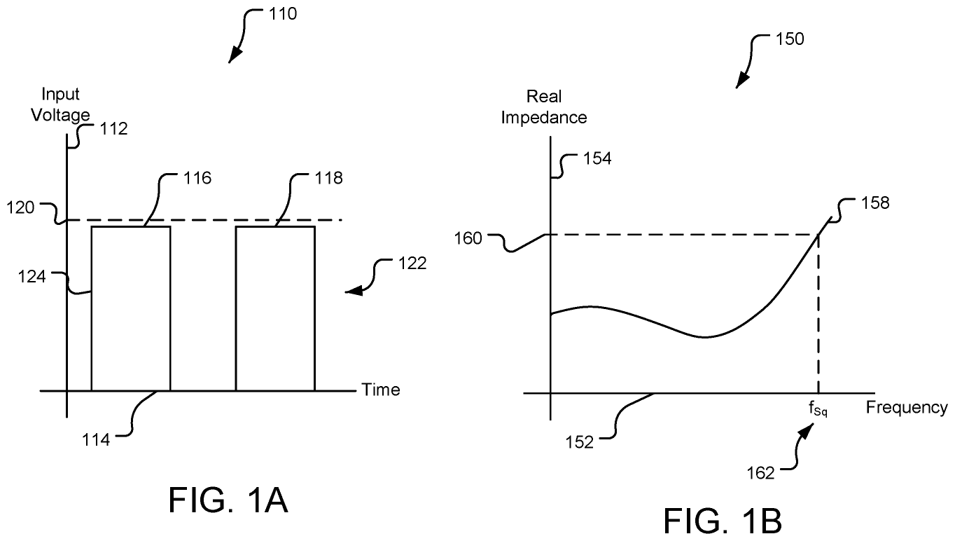

In some fast-charging scenarios, pulse charging has been explored. FIG. 1A illustrates a graph 110 of a direct current voltage signal 122 produced by a power source and applied to a battery cell to recharge the battery. The graph illustrates an input voltage 112 versus time 114 of the charge signal 122. In general, the power source may be controlled to provide a repeating pulse 122 to the electrodes of the battery cell to recharge the battery cell. In particular, the power source may be controlled to provide a repeating square-wave (illustrated as pulse 116 followed by pulse 118) signal to the battery cell. The peaks of the square-wave pulses 116, 118 may be less than or equal to a voltage threshold value 120 corresponding to operational constraints of the voltage source. A typical charge signal used to recharge a battery cell may apply a charging signal during a charging period, with a rest period of some duration between application of the charging signal to the anode of the battery cell. The operation of the charge circuit in this manner generates the illustrated power recharge signal 122 of FIG. 1A of a repeating square-wave pattern.

In some instances, however, applying a square-wave charge signal 122 to recharge a battery cell may degrade the life of the battery cell under recharge or may introduce inefficiencies in the recharging of the battery. For example, the abrupt application of charge current (i.e., the sharp leading edge 124 of the square-wave pulse 116) to the electrode (typically the anode) of the battery cell may cause a large initial impedance across the battery terminals. In particular, FIG. 1B illustrates a graph of estimated real impedance values of a battery cell to corresponding frequencies of a recharge signal applied to the battery cell in accordance with one embodiment. In particular, the graph 150 illustrates a plot of real impedance values (axis 154) versus a logarithmic frequency axis (axis 152) of frequencies of an input signal to the battery cell. The plot 150 illustrates real impedance values across the electrodes of a battery cell at the various frequencies of a recharge power signal used to recharge a battery. The shape and measured values of the plot 150 may vary based on battery type, state of charge of the battery, operational constraints of the battery, heat of the battery, and the like. However, a general understanding of the characteristics of a battery under charge may be obtained from the plot 158. In particular, real impedance values experienced at the electrodes of the battery cell may vary based on the frequency of the power charge signal provided to the battery, with a general sharp increase in real impedance values 328 at high frequencies. For example, an input power signal to the battery cell at frequency fsq 162 may introduce a high real impedance 160 at the battery cell electrodes, which may lessen the efficiency of the charging process and/or damage portions of the battery cell under charge.

Systems, circuits, and methods are disclosed herein for charging (recharging) one or more battery cells. The terms charging and recharging are used synonymously herein. Through the systems, circuits, and methods discussed, less energy may be required to charge a battery cell than through previous charging circuits and methods. Aspects of the present disclosure may provide several advantages, alone or in combination, relative to conventional charging. For example, the charging techniques described herein may reduce the rate at which an anode is damaged, may reduce heat generated during charging, which may have several follow-on effects such as reducing anode and cell damage, reducing fire or short circuit risks, and the like. In other examples, the charging techniques described herein may allow for higher charging rates to be applied to a cell and may thus allow for faster charging. The techniques may all optimize charge rates to be used, and which consider other issues such as cycle life and temperature. In one example, charge rates and parameters may be optimized to provide for a longer cell life and greater charging energy efficiency. In another example, in what might be considered “fast charging,” the disclosed systems and methods provide an improved balance of charge rate and cell life, while producing less heat.

In one example, the various embodiments discussed herein charge a battery cell by generating a shaped charge signal and/or heating signal that is shaped using a transistor, although an example of a pair of transistors is primarily discussed herein, controlled through a signal shaping generator. In one example, one or both of the pair of transistors may be controlled with a pulse-width modulation (PWM) signal with a duty cycle. The PWM signal is applied to the gates of the respective transistors to produce a sequence of pulses, which when applied to an inductor or inductors, or other elements, produces a shaped waveform that may be applied to the battery. In an aspect, the duty cycle of the PWM controlling the operation of the transistors correlates to a charge current applied to the battery, such that a higher duty cycle of the PWM control signal results in a higher current applied to charge the battery. The signal shaping generator may receive a target shaped charge signal and use the duty cycle of the PWM control signal to shape a charge signal for the battery that corresponds to the target shape. Since there may be various factors that affect generating the charge signal shape (e.g., temperature, battery state of charge, circuit element variability, etc.), the system may iterate to the target shape. In some instances, the charge signal may be a repeating pattern of shaped signals, and the shaping process may be executed iteratively to shape subsequent portions of the charge signal closer and closer to the target charge signal shape. This iterative process may include controlling the transistors at a first duty cycle of the PWM control signal, receiving a measurement of some aspect of the battery under charge, determining an error between the measurement and a target performance, and adjusting the duty cycle of the PWM control signal based on the determined error. The charge signal for the battery is therefore iteratively shaped to match or approximate the shape of the target charge signal through multiple adjustments to the duty cycle of the PWM signal. This shaped charge signal may provide a more efficient charge signal for the battery that mitigates damaging effects of various conventional DC charge signals among others. While the initial discussion below focuses on generating a shaped charge signal, many concepts may also be applied toward the generation of a shaped heating signal (e.g., a signal having an oscillating, sinusoidal, linear, ramped, and/or stepped shape).

The term “battery” in the art and herein can be used in various ways and may refer to an individual cell having an anode and cathode separated by an electrolyte, solid or liquid, as well as a collection of such cells connected in various arrangements. A battery or battery cell is a form of electrochemical device. Batteries generally comprise repeating units of sources of a countercharge and electrode layers separated by an ionically conductive barrier, often a liquid or polymer membrane saturated with an electrolyte. These layers are made to be thin so multiple units can occupy the volume of a battery, increasing the available power of the battery with each stacked unit. Although many examples are discussed herein as applicable to a battery, it should be appreciated that the systems and methods described may apply to many different types of batteries ranging from an individual cell to batteries involving different possible interconnections of cells, such as cells coupled in parallel, series, and parallel and series. For example, the systems and methods discussed herein may apply to a battery pack comprising numerous cells arranged to provide a defined pack voltage, output current, and/or capacity. Moreover, the implementations discussed herein may apply to different types of electrochemical devices such as various different types of lithium batteries including but not limited to lithium-metal and lithium-ion batteries, lead-acid batteries, various types of nickel batteries, and solid-state batteries of various possible chemistries, to name a few. The various implementations discussed herein may also apply to different structural battery arrangements such as button or “coin” type batteries, cylindrical battery cells, pouch battery cells, and prismatic battery cells.

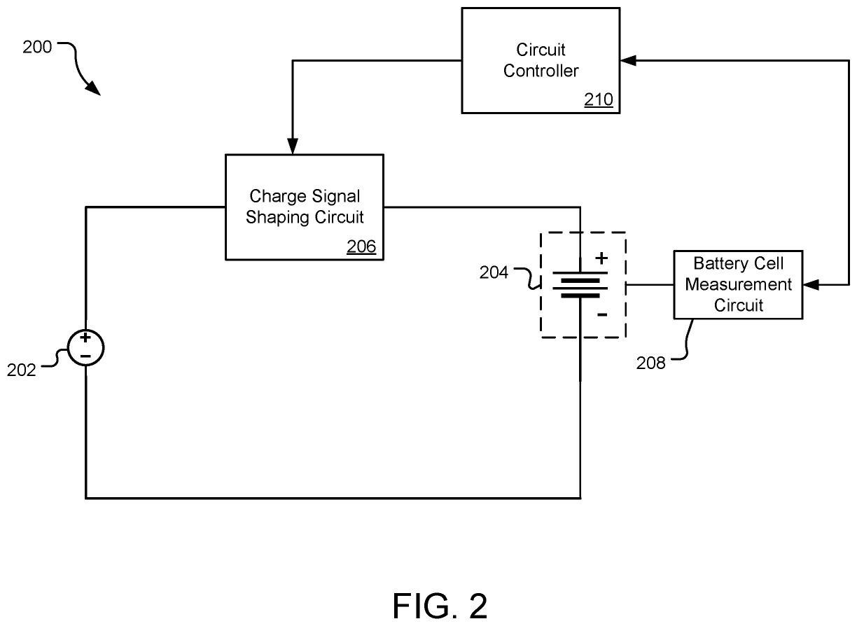

FIG. 2 is a schematic diagram illustrating an example system 200 for recharging a battery cell 204 utilizing a charge signal shaping circuit 206 and battery cell measurement circuit 208 in accordance with one embodiment. In general, the system 200 may include a power source 202, which may be a voltage source or a current source. In one particular embodiment, the power source 202 is a direct current (DC) voltage source, although alternating current (AC) sources are also contemplated. More particularly, the power source 202 may include a DC source providing a unidirectional current, an AC source providing a bidirectional current, or a power source providing a ripple current (such as an AC signal with a DC bias to cause the current to be unidirectional. The power source 202 supplies the charge current that may be shaped and used to charge the battery cell 204. In one particular implementation, the system 200 of FIG. 2 may include a charge signal shaping circuit 206 to shape one or more aspects of a charge signal for use in charging the battery cell 204. A circuit controller 210 may provide one or more inputs to the power signal shaping circuit 206 to control the shaping of the charge signal. The inputs may be used by the shaping circuit 206 to alter a signal from the power source 202 into a more efficient power charging signal for the battery cell 204. The operation and composition of the charge signal shaping circuit 206 is described in more detail below.

In some instances, the charge signal shaping circuit 206 may alter energy from the power source 202 to generate a charge signal that is shaped based on charge conditions at the battery cell 204, such as a charge signal that at least partially corresponds to a harmonic associated with a minimum real impedance value of the battery cell 204. In one example, the system 200 may include a battery cell measurement circuit 208 connected to the battery cell 204 to measure cell voltage and/or charge current, as well as other cell attributes like temperature and measure or calculate the impedance across the electrodes of the cell 204. In one example, battery cell characteristics may be measured based on the applied charge signal. In another example, battery cell characteristics may be measured as part of a routine that applies a signal (e.g., a probing signal) with varying frequency attributes to generate a range of sampled battery cell characteristic values associated with the different frequency attributes to characterize the cell, which may be done prior to charging, during charging, periodically during charging, and may be used in combination with look-up techniques, and other techniques. The battery cell 204 characteristics may vary based on many physical of chemical features of the cell, including a state of charge and/or a temperature of the cell. As such, the battery cell measurement circuit 208 may be controlled by the circuit controller 210 to determine various battery cell characteristic values during recharging of the cell, among other times, and provide the measured battery cell characteristic values to the circuit controller 210.

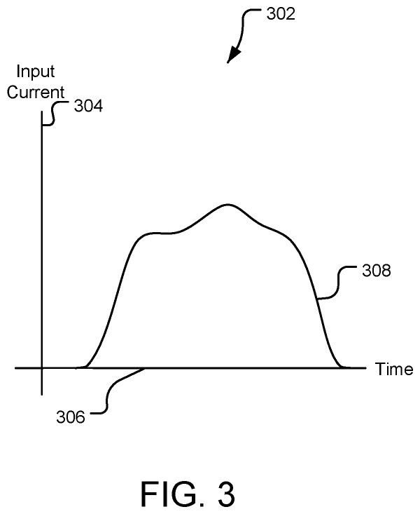

Based on the battery cell characteristics, the circuit controller 210 may generate an intended charge signal for efficient charging of the battery cell 204. For example, a real component of a measured impedance of the battery cell 204 may be used by the circuit controller 210 to sculpt or shape energy from the power source 202 into one or more charge signals that correspond to a harmonic associated with a minimum real impedance value of the battery cell 204. As such, the circuit controller 210 may execute a charge signal algorithm that outputs an intended charge signal shape (also referred to herein as a target charge signal shape) based on measured or estimated charging conditions of the battery cell 204. The circuit controller 210 may then generate one or more control signals based on the charge signal algorithm and provide those control signals to the charge signal shaping circuit 206. The control signals may, among other functions, shape the charge signal to approximate the intended shaped charge signal determined by the algorithm. In some instances, the intended shaped charge signal may be any shaped charge signal, such that the charge signal does not conform to a traditionally repeating charge signal, such as a repeating square wave or triangle wave charge signal. For example, FIG. 3 is a signal diagram 302 of a shaped battery cell charging signal 308 for charging a battery cell 204. The signal diagram 302 illustrates a charge signal 308 graphed as input current 304 versus time 306. The shape of the charge signal 308 may be determined by a charge signal algorithm or program executed by circuit controller 210. In one instance, the shape of the charge signal 308 may be based on characteristics of the battery cell 204, such as a minimum real impedance value of the battery cell. In another example, the shape of the charge signal 308 may correspond to a harmonic associated with both the real and imaginary impedance value of the cell. In still another example, the charge signal 308 may correspond to a harmonic associated with one or both of a conductance or susceptance of an admittance of the battery cell 204. In general, the charge signal shaping algorithm of the circuit controller 210 may sculpt or otherwise determine the shape of the charge signal 308 based on any characteristics of the battery cell 204, either measured, modeled, or estimated.

Further, as the characteristics of the battery cell 204 may change due to state of charge, temperature, and other factors, the shape of the charge signal 308 may also be changed over time. The circuit controller 210 may therefore, in some instances, perform an iterative process of monitoring or determining characteristics of the battery cell 204 and adjust the shape of the charge signal 308 applied to the battery cell accordingly. This iterative process may improve the efficiency of the charge signal used to recharge the battery cell 204, thereby decreasing the time to recharge the battery, extending the life of the battery (e.g., the number of charge and discharge cycles it may experience), optimizing the amount of current charging the battery, and avoiding energy lost to various inefficiencies, among other advantages.

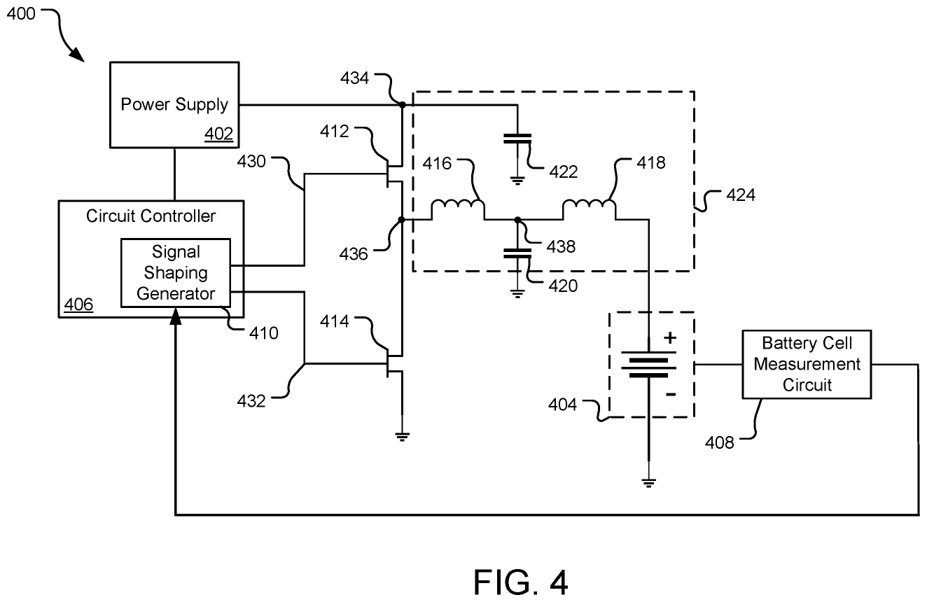

FIG. 4 is a schematic diagram illustrating a system 400 for charging a battery cell 404 utilizing two switching elements 412, 414 to shape a charge signal for charging the battery cell, in accordance with one embodiment. The system 400 includes elements described above with reference to simplified charging system 200 of FIG. 2, including power supply 402, circuit controller 406, battery cell measurement circuit 408, and battery cell 404. Other elements illustrated in the system 400 of FIG. 4 may be included in charge signal shaping circuit 206 of FIG. 2. Thus, as explained in more detail below, the circuit controller 406 may provide one or more control signals 430, 432 to elements of the system 400 to shape a current or voltage signal from the power supply 402 to charge the battery cell 404. The circuit controller 406 may be implemented through a Field Programmable Gate Array (FPGA) device, a microcontroller, an Application-Specific Integrated Circuit (ASIC), or any other programmable processing device. In one implementation, the circuit controller 406 may include a charge signal shaping generator 410 to generate the one or more control signals 430, 432 to shape the charge signal to be applied to the battery cell 404. The charge signal shaping generator 410 and/or the circuit controller 406, in some instances, receive measurements of characteristics of the battery cell from the battery cell measurement circuit 408 for use in determining the shape of the charge signal.

As mentioned, the system 400 may include one or more components to shape a charge signal for charging a battery cell 404. In the particular implementation shown, the system 400 may include a first switching element, e.g., transistor 412, and a second switching element, e.g., transistor 414, connected in series to an output 434 of the power supply 402. The first transistor 412 may receive an input signal 430 to operate the first transistor 412 as a switching device or component. In one particular implementation, the control signal 430 may be a pulse-width modulation (PWM) control signal, as explained in more detail below. In general, the first transistor 412 may be any type of transistor, e.g., a FET, or any type of controllable switching element for controllably connecting a first inductor 416 to the output 434 of the power supply 402. For example, the first transistor 412 may be a FET with a drain node connected to the first inductor 416, a source connected to the power supply 402, and a gate receiving the control signal 430 from the circuit controller. The control signal 430 may be provided by the circuit controller 406 (via the signal shaping generator 410) to control the operation of the first transistor 412 as a switch that, when closed, connects the first inductor 416 to the power supply 402 such that the charge signal from the power supply flows through the first inductor 416. The second transistor 414 may receive a second input signal 432 and may also be connected to the drain of the first transistor 412 at node 436. In some instances, the second input signal 432 may be a PWM signal substantially opposite of the first control signal 430 to the first transistor 412. Thus, except for a small period of dead time where both transistors are open, when the first transistor 412 is closed to connect the first inductor 416 to the power supply 402, the second transistor 414 is open. When the first transistor 412 is open, conversely, the second transistor 414 is closed, connecting node 426 and the first inductor 416 to ground. Although the first control signal 430 and the second control signal 432 are described herein as opposing signals to control the transistors into opposing states, other techniques for controlling the switching elements 412, 414 may also be implemented with the system 400. The inductor value, the capacitor value, the time and frequency of actuating the transistors, and other factors can be tailored to generate a waveform and particularly a waveform with controlled harmonics to the battery for charging the same.

In addition to the first inductor 416, other components may be included in the system 400, collectively referred to as a “filter” 424 portion of the circuit. In particular, the system 400 may include a first capacitor 422 connected between the output 434 of the power supply 402 and ground. A second capacitor 420 may be connected between the first inductor 416 (at node 438) and ground. A second inductor 418 may be connected between node 438 and an anode of the battery cell 404. The filter 424 of the system 400 may operate, in general, to prevent rapid changes to the charge signal applied to the battery cell 404. For example, upon closing of the first transistor 412 based on control signal 430, first inductor 416 and second inductor 418 may prevent a rapid increase in current transmitted to the battery cell 404. Such rapid increase in current may damage the battery cell 404 or otherwise be detrimental to the life of the battery cell. Moreover, the inductor may shape the waveform applied to the battery, and control of the signal applied to the inductor may provide for controlled shaping of the waveform. In another example, capacitor 420 may store energy from the power supply 402 while first transistor 412 is closed. Upon opening of the first transistor 412, the capacitor 420 may provide current to the battery cell 404 through second inductor 418 to resist an immediate drop of current to the battery and may similarly be used to controllably shape the waveform applied to the battery. Other advantages for charging of the battery cell 404 are also realized through filter circuit 424 but are not discussed herein for brevity.

It should be appreciated that more or fewer components may be included in charge system 400. For example, one or more of the components of the filter circuit 424 may be removed or altered as desired to filer the charge signal to the battery cell 404. Many other types of components and/or configurations of components may also be included or associated with the charge system 400. Rather, the system 400 of FIG. 4 is but one example of a simple battery cell charging system 400 and the techniques described herein for utilizing a circuit model for generating or otherwise determining control signals 430, 432 for shaping a charge signal may apply to any number of battery cell charging circuits.

As described above, the signal shaping generator 410 of the circuit controller 406 may control the shape of the charge signal based on feedback measurements of the battery cell 404 received from the battery cell measurement circuit 408. For example, an initial charge signal may be applied to the battery cell 404 and one or more measurements of the battery cell 404 (such as a current into battery cell or a voltage across the battery cell) may be obtained by the battery cell measurement circuit 408. These measurements may be provided to the signal shaping generator 410 which may, in turn, determine an error between an expected measurement of the battery cell characteristic and a measured value at the battery cell 404. Based on this determined error, the signal shaping generator 410 may control, via control signals 430, 432, the first transistor 412 and the second transistor 414 to adjust the shape of the charge signal to the battery cell 404. In other words, the signal shaping generator 410 may sculpt the charge signal transmitted to the battery cell 404 to generate an expected measured characteristic of the battery cell 404. As long as the feedback measurements are expected, the shape of the charge signal may be maintained by the signal shaping generator 410 via the control signals 430, 432. A detected difference between an expected measurement and a measured value, however, may cause the circuit controller 406 to alter the shape of the charge signal to bring the battery cell 404 response into an expected range of values.

In one implementation, the control signals 430, 432 transmitted to the first transistor 412 and the second transistor 414 may comprise complementary pulse-width modulation (PWM) signals that alternate between an on state and an off state at a high frequency. In particular, the first control signal 430 may control the first transistor 412 to rapidly alternate between a conducting state (or “on” state) and a non-conducting (or “off” state). As the second control signal 432 may control the second transistor 414 to operate opposite of the first transistor 412, the second transistor may also be controlled by a PWM signal to rapidly alternate between an on state and an off state opposite the first transistor. The PWM control signals 430, 432 may be described through a “duty cycle” of the signal. The duty cycle of a PWM signal is the amount of time the signal is in the “active” state relative to the period of the signal. In general, the duty cycle of a PWM signal is given as a percentage. For example, a perfect square wave with equal high time and low time has a duty cycle of 50%. As the PWM signal controls the amount of time the first transistor 412 is “on” or conducting, the duty cycle of the PWM signal may correlate to the amount of current provided to charge the battery cell 404 from the power source 402. In this manner, the operation of the transistors 412, 414 through the provided PWM signals 430, 432 may alter portions of the magnitude of the signal from the power supply 402 to shape or sculpt the charge signal to the battery cell 404. In particular, control of the frequency, or duty cycle, of the PWM control signals 430, 432 may siphon more or less energy from the charge signal to shape the signal. One method for controlling the duty cycle of the PWM control signals 430, 432 to the transistors 412, 414 is described in more detail below.

As mentioned, the control over the duty cycle of the PWM control signals 430, 432 to attain a target charge signal shape may be based on one or more measurements of the battery cell 404. In particular, the signal shaping generator 410 or the circuit controller 406 may generate a target shape for a charge signal for charging the battery cell 404. The intended or target charge signal shape may include a sequence of current values or voltage values of the shaped charge signal. For example, the target charge signal shape may include a first entry of 0 amps, a second entry of 0.01 amps, a third entry of 0.02 amps, and so on to indicate a rising edge of the shaped charge signal. Each entry in the sequence may correspond to a length of time of the charge signal. To indicate a falling edge of the shaped charge signal, the target charge signal shape may include a series of entries with smaller amp values. As should be appreciated, other aspects of the shaped charge signal, such as a voltage, may be included in the entries describing the shaped charge signal. The aspects of the target shaped charge signal that are included in the target series may, in some instances, correspond to a measurement of the battery cell 404 obtained by the battery cell measurement circuit 408 such that a comparison of the measurement to the entries in the target shaped charge signal may be conducted.

The signal shaping generator 410 may utilize the target shape to begin shaping a charge signal for the battery, including altering a duty cycle of the PWM control signal 430, 432 for the first transistor 412 and the second transistor 414. In addition, one or more measurements of the battery cell 404 may be received at the circuit controller 406, such as from the battery cell measurement circuit 408. Such measurements may be utilized by the signal shaping generator 410 to determine an error between the applied shaped charge signal and the target charge signal. For example, a shaped charge signal may be applied to the battery cell 404 to generate an expected battery cell measurement, such as a current into the battery cell or a voltage across the battery. The signal shaping generator 410, as explained in more detail below, may compare the battery cell measurement to the expected battery cell response to determine an error between the expected and the measured. In response to the determined error, the signal shaping generator 410 may alter the duty cycle of the PWM control signals 430, 432. Altering the duty cycle of the PWM control signals 430, 432 may cause more or less current to be included in the charge signal for the battery cell 404. For example, an increase in the duty cycle of the PWM control signals 430, 432 may provide more current to the shaped charge signal and a decrease in the duty cycle of the control signals may provide less current. This shaping of the charge signal based on a target shape and feedback measurements from the battery measurement circuit 408 may be executed in an iterative manner to shape the charge signal over time to match or approximate the target charge signal shape.

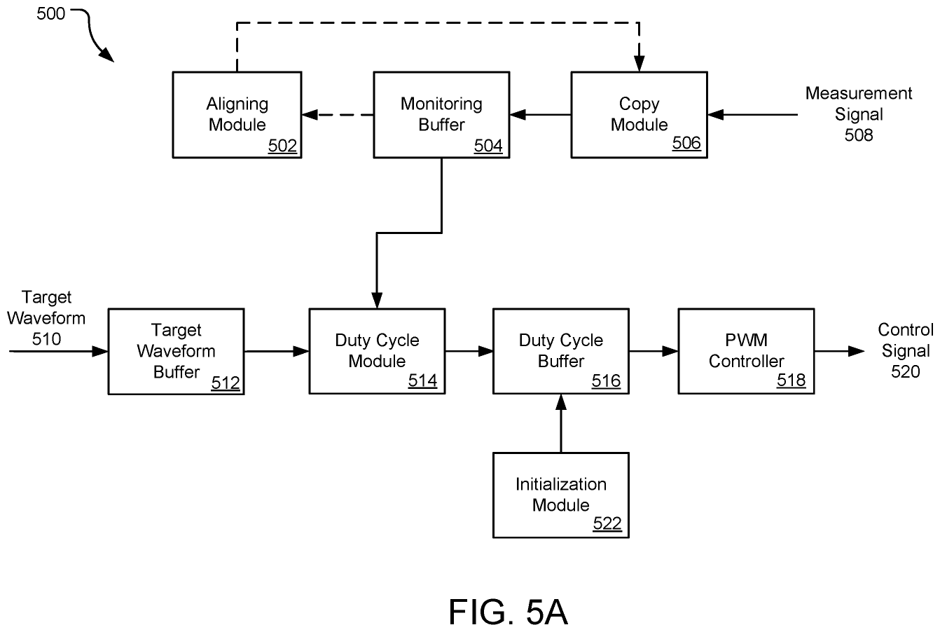

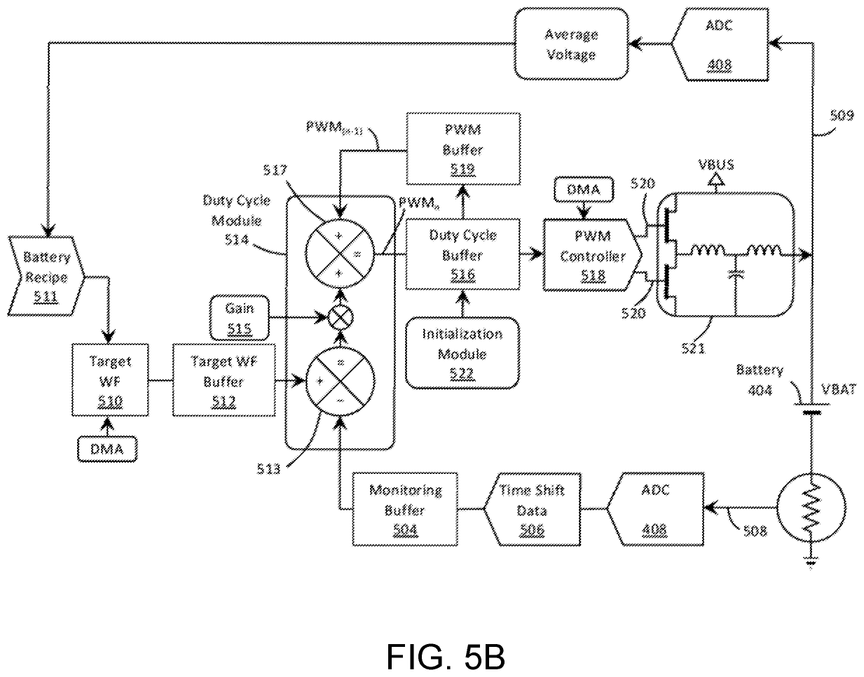

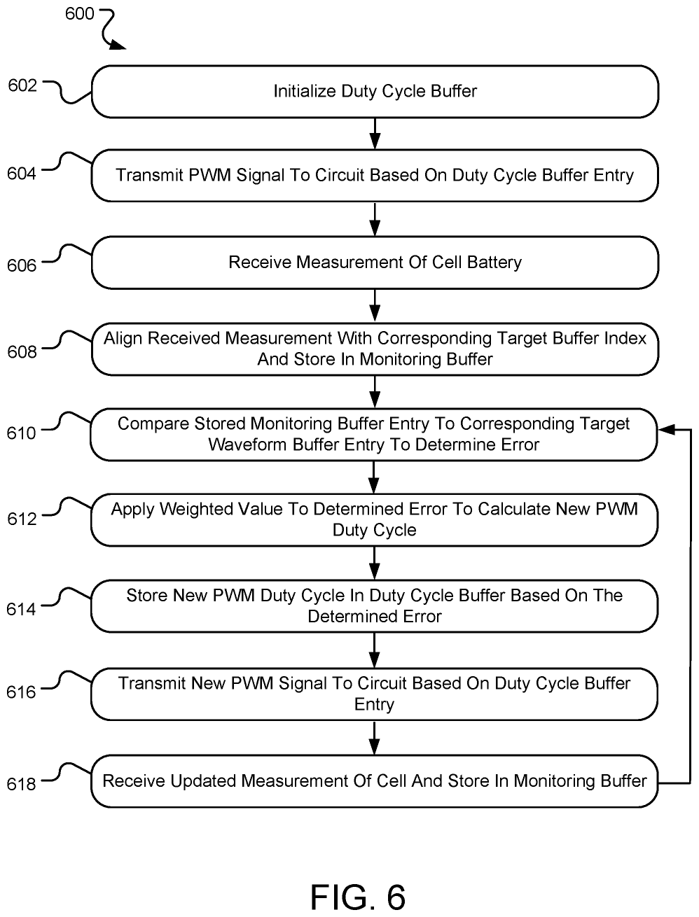

The signal shaping generator 410 may include one or more components or modules to control the duty cycle of the PWM control signals 430, 432 in response to a determined error between a target charge signal and a measured charge signal. For example, FIGS. 5A and 5B illustrate some components of the signal shaping generator 410 used to alter a duty cycle of a PWM control signal to shape a charge signal for a battery cell 404 in accordance with one embodiment. The signal shaping generator 410 may include more or fewer such modules from those illustrated. In some instances, one or more of the modules or components may be included in the circuit controller 406, the signal shaping generator 410, or any other aspect of a battery charge circuit. Operations of the components and/or modules of the signal shaping generator 410 are described in detail below with reference to the method 600 of FIG. 6. In particular, the signal shaping generator 410 may, through the modules of FIGS. 5A and 5B, execute one or more operations of the method 600 to generate the control signals 430, 432 to the first transistor 412 and the second transistor 414 to adjust the shape of the charge signal to the battery cell 404. More particularly, the signal shaping generator 410 may control a duty cycle of the PWM control signals 430, 432 to the first transistor 412 and the second transistor 414 in response to a target waveform and one or more measurements of the battery cell 404.

Referring to FIG. 5A, the charge signal shaping system 500 of FIG. 5 includes an initialization module 522 that may store an initial duty cycle value. The initialization duty cycle value may be seeded in a duty cycle buffer 516 upon an initialization of the charge system 400 at operation 602. In one implementation, the charge system 400 may execute an initialization upon connection of a battery cell 404 to be charged by the charge circuit. For example, the charge system 400 may be included with a charger for a portable battery for a portable electronic device, such as for a power tool, vacuum, or any number of different devices. Upon connection of the battery cell 404 to the circuit 440, the duty cycle buffer 516 may be initialized with the initialization value from the initialization module 522. The initialization value may be associated with or indicate an initial duty cycle of the PWM control signal to be provided to the first and second transistors 412, 414 to start the battery cell charge signal with an initial shape. In one particular implementation, the initial duty cycle may correspond to an initial charge current of zero amps to the battery cell 404. In other words, the initial duty cycle of the PWM control signal may correspond to a charge current applied to the battery cell 404 from the power supply 402. As noted above, a higher duty cycle (corresponding to the first transistor 412 being in a conducting state more often than the second transistor 414) may correspond to a higher charge current provided to the battery cell 404. In some implementations, the duty cycle of the control signals 430, 432 is substantially linearly related to the current of the charge signal applied to the battery cell 404 such that an increase in the duty cycle corresponds to an increase in the charge current provided to the battery. In one example, the duty cycle stored in the duty cycle buffer 516 corresponding to a zero current charge signal may be approximately 51% such that first transistor 412 is on or conducting about 51% of the time in comparison to an off time. In this example, the initial duty cycle value provided by the initialization module 522 may be 0.51 or some other value corresponding to a zero-charge current signal. In another implementation, the initialization module 522 may be loaded with an estimate of the target waveform as determined by the circuit controller 406 or other computing device. For example and as described above, the circuit controller 406 may generate the target waveform shape based on one or more parameters or measurements of the battery cell 404, either obtained during a current charging cycle or from a previous charging cycle. In some instances, the one or more parameters of the battery cell 404 may be based on a model of the battery cell received at or generated by the circuit controller 406. The model of the battery cell 404 may include estimates of characteristics of the battery cell during any stage of a charging process. In another implementation, the initial value loaded into the duty cycle buffer 516 from the initialization module 522 may be based on one or more parameters of the charge system 400, such as the value of the components utilized in the circuit or other operating conditions of the circuit. In general, the initial duty cycle value stored in the duty cycle buffer 516 from the initialization module 522 may be any value to generate an initial duty cycle of the PWM control signals 430, 432 to provide an initial current (or other charge signal aspect) to the battery cell 404.

In operation 604, the initial duty cycle value from the initialization module 522 stored in the duty cycle buffer 516 may be transmitted to the PWM controller 518 and converted to control signals 520 for transistors 412, 414. In particular, the PWM controller 518 may generate one or more PWM control signals 520 based on the value stored in the duty cycle buffer 516. In one example, the PWM control signal 520 may control the transistors 412, 414 of the system 400 to provide an initial zero current charge signal to the battery 404 based on the initial duty cycle value. As described above, the control signals 520 may control the first transistor 412 and the second transistor 414 to provide an initial current charge signal to the battery cell 404 through the PWM signal provided to each transistor. In operation 606, a measurement signal 508 corresponding to a measurement of the battery cell 404 may be received at copy module 506, such as from battery cell measurement circuit 408. The measurement signal or value 508 may correspond to any measurement of an aspect of the battery cell 404, such as a current through the battery cell, a voltage across the battery cell, a resistance of the battery cell, an impedance of the battery cell, a temperature of the battery cell, or any other aspect of the battery cell. The measurement signal 508 may correspond to an effect on the battery cell 404 from the charge signal generated from the initial duty cycle value. Upon receipt, the measurement signal or value 508 may be stored in a copy module 506. For example, the measurement signal 508 may comprise a measured current into the battery cell 404 in response to the initial duty cycle of the PWM control signals 430, 432. The current measurement, such as a measurement in milliamps or other measurement unit, may be stored in the copy module 506. In one particular example, the measurement signal 508 may comprise a zero current or near zero current value based on the initial duty cycle value for the PWM control signals 430, 432.

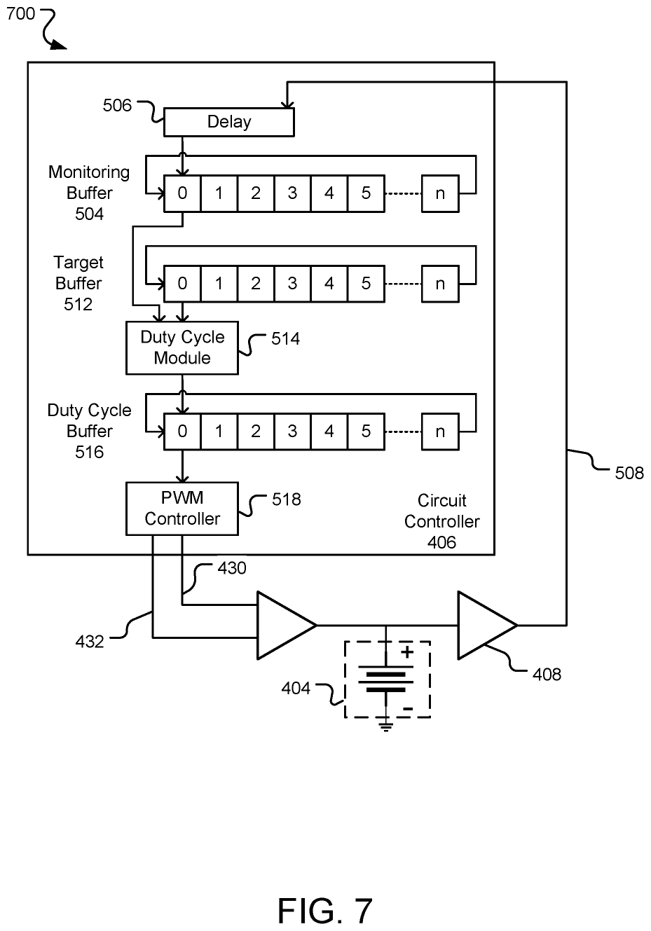

At operation 608, the received measurement from the copy module 506 may be aligned with a corresponding target buffer index and stored in the monitoring buffer 504 accordingly. For example, FIG. 7 illustrates a flow of data for iteratively altering a duty cycle of a pulse-width modulated signal to shape a charge signal for a battery cell 404 utilizing the system 500 of FIG. 5. As discussed above, the PWM controller 518 may generate one or more control signals (430, 432) to the charge circuit to provide an initial current charge signal to the battery cell 404. In addition, a measurement of a characteristic of the battery cell 404 may be measured by the battery cell measurement device 408 and a measurement signal 508 of the measurement may be transmitted or otherwise provided to the circuit controller 406. However, the application of the charge signal to the battery cell 404 and obtaining the measurement of the battery cell may take some time. As such and as illustrated in the diagram 700 of FIG. 7, the measurement 508 may be received at the circuit controller 406 delayed (e.g., at index value 3 in FIG. 7). For example, each of the buffers illustrated in FIG. 7 continually transmit the next value stored in the buffer at each clock cycle. For example, the monitoring buffer 504 may provide the data of index value 0 to the duty cycle module 514 at a first time. The duty cycle buffer 516 may also provide the data from index value 0 to the PWM controller 518. In this manner, the data of each buffer is output sequentially on each clock cycle of the circuit controller 406. As the charge signal is applied to the battery cell 404 and the characteristic of the battery is measured and provided back to the circuit controller, the buffers may continue to sequentially output the data stored in the buffers at each clock cycle. This delay is illustrated in FIG. 7 as delay 506. In the shown example, the measurement signal 508 is received as the buffers output the data values from index value 3, resulting in delay 506. In general, however, the delay 506 may be any length of time for the circuit controller 406 to receive the measurement signal 508. Further, the copy module 506 may also be configured to scale the measurement signal 508 to correspond to the values of the target waveform buffer 512 such that a comparison of the measurement signal and the target waveform 510 may occur at the duty cycle module 514, discussed in more detail below.

To align the received measurement with the corresponding target buffer index 512, the aligning module 502 may further delay the entry of the measurement into the monitoring buffer 504. For example, the aligning module 502 may instruct the copy module 506 to wait until the index of the monitoring buffer 504 returns to the first index (index value 0) before storing the received measurement in the monitoring buffer 504. In this implementation, the measurement values are stored in the monitoring buffer 504 one charge waveform behind. In particular, the effect of the value of the duty cycle buffer 516 on the battery cell 404 is stored in the monitoring buffer 504 at the beginning of the next charge waveform such that each measurement is delayed by a full charge wavelength. In another implementation, the aligning module 502 may cause the measurement signal 508 to be stored in the monitoring buffer 504 in the index position the buffer is at when the measurement signal is received. The aligning module 502 may then change the index value of the target buffer 512 to align with the index position in which the measurement signal is stored in the monitoring buffer 504. Regardless of the mechanism, the aligning module 502 may ensure that the index values for the monitoring buffer 504 and the target buffer 512 align such that the proper measurement values and corresponding target waveform values are received during the same clock cycle at the duty cycle module 514. A comparison of the aligned measurement value and target waveform value may then be conducted.

As discussed, the entry in the monitoring buffer 504 may be provided to the duty cycle module 514 in operation 610. Upon receiving the measurement value from the monitoring buffer 504, the duty cycle module 514 may compare the measurement signal value 508 received from the monitoring buffer 504 to the corresponding entry in the target waveform buffer 512. In one implementation, a target waveform 510 may be generated by the circuit controller 406 and provided to the target waveform buffer 512. More particularly, the target waveform 510 may be quantized into a series of values that approximates a target shape for the charge signal. The quantized values of the target waveform 510 may be provided to and stored in the target waveform buffer 512 as a series of values. Each entry may be associated with a sequence value that indicates the entry's position within the sequence describing the target shaped charge signal. The duty cycle module 514 may thus obtain the corresponding entry of the target waveform 510 from the target waveform buffer 512. In addition, the duty cycle module 514 may compare the corresponding entry of the target shaped charge signal from the buffer 512 to the received entry from the monitoring buffer 504 to determine an error between the generated charge waveform and the target charge waveform 510. For example, the measured value 508 may indicate that the charge signal is applying 0 milliamps to the battery 404. However, the corresponding entry in the target waveform buffer 512 indicates the charge current should be 1 milliamp. In this example, the duty cycle module 514 may determine a difference between the measurement value received from the monitoring buffer 504 and the corresponding entry in the target waveform buffer 512. The corresponding entry in the target waveform buffer 512 may indicate the corresponding target current for the shaped charge signal for the battery cell 404. In particular, the error indicates that the applied charge current, in response to the controlled duty cycle of the PWM signal, is less than the corresponding target charge current for the shaped charge signal. The duty cycle module 514 may then determine that the charge signal applied to the battery 404 may be adjusted according to the determined error. Thus, for the same index (time aligned data), the monitoring buffer data is compared to the target buffer data and then compared to PWM data buffer that generated the monitoring data. The index is the time alignment, thus the delay/move of the monitoring data to the correct index via delay 506. The comparison of monitoring buffer 504 to target buffer 512 allows for adjusting a new value for the same index in the duty cycle buffer 516.

In particular, the duty cycle module 514 may begin a process to adjust the duty cycle of the PWM signal to the transistors 412, 414 of the charge system 400 based on the determined error between the measured value 508 of the battery cell 404 and the target charge waveform shape 510. In one implementation, the duty cycle module 514 may apply a weighted value to the determined error to calculate a new PWM duty cycle, in operation 612. The weighted value may be based on the value of the determined error. For example, a small error value may correspond to a small-weighted value, while a large error value may correspond to a large-weighted value. In general, the weighted values may be utilized by the duty cycle module 514 to compensate for the determined error and try to synchronize the applied charge signal with the target charge signal 510. Thus, a large difference between the applied charge signal and the target charge signal may result in a large-weighted value applied to the duty cycle to more quickly bring the applied charge signal in line with the target signal. Alternatively, a smaller difference between the applied charge signal and the target charge signal may result in a relatively small-weighted value applied to the duty cycle to fine-tune the applied charge signal to approximate the target charge signal 510. In one implementation, the applied weighted value may be based on the determine error value being within a range of error values. For example, an error value between 1-10 amps may result in a first weighted value, while an error value between 10-20 amps may result in a second, higher weighted value, and so on. In general, the ranges of differences between the measurement signal 508 and the target waveform 510 may correspond to any weighted value to adjust the shaped charge signal according to the determined error difference.

In operation 614, the new PWM duty cycle value determined by the duty cycle module 514 based on the error between the measurement value and the target waveform, and the applied weighted value may be provided to the duty cycle buffer 516. In particular, a new PWM duty cycle value based on the determined error may be provided to the PWM controller 518, which may in turn provide the control signals 430, 432 to the transistors 412, 414 to adjust the duty cycle of the PWM signal of the transistors. As should be appreciated, the adjusted duty cycle of the PWM signal may be based on the determined error of the measured value 508 and the target waveform 510 from the target waveform buffer 512 to approximate the applied charge signal to the target charge signal waveform. For example, a determine error indicating that the measured value 508 is higher than the value of the target waveform 510 may result in a lower duty cycle value of the PWM signal and stored in the duty cycle buffer 516. Alternatively, a determine error indicating that the measured value 508 is lower than the value of the target waveform 510 may result in a higher duty cycle value of the PWM signal stored in the duty cycle buffer 516. In this manner, the duty cycle module 514 may determine a duty cycle value for the PWM control signal 520 based on the determined difference between the measured value (from the monitoring buffer 504) and the target waveform value 510 (from the target waveform buffer 512). As above, the new PWM duty cycle value may be provided to the PWM controller 518 and transmitted or applied to the system 400 in operation 616.

In response to the transmission of the adjusted duty cycle of the PWM control signal 520, the charge signal for the battery 404 may be shaped or altered according to the adjustment to the duty cycle. For example, a higher duty cycle of the PWM control signal 520 may increase the current provided to the battery cell 404, while a lower duty cycle may decrease the current. A new measurement value or signal 508 corresponding to the shaped charge signal may be obtained by the battery cell measurement circuit 408 and provided to the signal shaping generator 410 as measurement signal 508. The received measurement signal or value 508 may be stored in the copy module 506 and/or monitoring buffer 504 in operation 618. Returning to operation 610, the duty cycle module 514 may compare the newly stored measurement value to the corresponding entry in the target waveform buffer 512 to determine a new error and adjust the duty cycle of the PWM control signal 520 as described above. The new duty cycle may be applied to the control system 400 to further shape the charge signal provided to the battery cell 404. This iterative process may continue over and over to shape the charge signal based on the target shape determined by the circuit controller 406. The adjustment to the shaped charge signal may occur periodically at a rate achievable by the charge system 400. In some instances, the adjustment of the duty cycle of the PWM control signals 430, 432 may occur every nth cycle of the charge signal such that multiple charge signals may be provided to the battery cell 404 before the charge signal approximates the determined target shape. In other words, the shaping of the charge signal may occur over many charge signal pulses. In other implementations, however, the shaping of the charge signal may occur in real-time or in near real-time to approximate the target charge signal shape.

In addition to the above operations, the signal shaping generator 410 may also include an aligning feature to better approximate the determined error between the measured aspect of the battery cell 404 and the target waveform 510. For example, some time may pass between adjusting the duty cycle of the PWM control signals 430, 432 and the measurement signal 508 being received at the copy module 506 that includes the measurement of the battery cell in response to the adjusted control signals. Thus, the effect on the battery cell 404 in response to an adjustment to the duty cycle for a first entry in the target waveform buffer 512 may not appear in monitoring buffer 504 until a later time. In this manner, the measurement value 508 stored in the monitoring buffer 504 may be delayed in comparison to the corresponding entry in the target waveform buffer 512 such that the duty cycle module 514 compares an incorrect measurement of the battery cell 404 to the corresponding entry in the target waveform buffer 512 in operation 610. To ensure that the duty cycle module 514 compares the measurement value in the monitoring buffer 504 to the corresponding entry in the target waveform buffer 512, an aligning module 502 may be included in the signal shaping generator 500. The aligning module 502 may monitor the measurement values stored in the monitoring buffer 504 to identify for a particular adjustment to the duty cycle of the control signals 430, 432.

In one example, the target waveform 510 as stored in the target waveform buffer 512 may include a test “peak” duty cycle at some known point within the target waveform 510. This peak duty cycle may be configured to generate an impulse response in the measured aspect of the battery cell 404 that is identifiable by the aligning module 502. Upon control of the duty cycle of the PWM signals in response to the peak duty cycle, the resulting battery cell measurement 508 may be stored in the monitoring buffer 504 and detected by the aligning module 502. Upon detection, the aligning module 502 may determine if the resulting battery cell measurement from the peak duty cycle corresponds to the peak duty cycle entry in the target waveform buffer 512. In some instances, the entries may be misaligned such that the value of the monitoring buffer 504 are compared to the incorrect entry in the target waveform buffer 512 by the duty cycle module 514. In such instances, the aligning module 502 may communicate with the copy module 506 to adjust how the copy module populates the monitoring buffer 504. For example, the copy module 506 may skip a received measurement value to move the entries in the monitoring buffer 504 ahead one entry to align with the target waveform buffer 512 entries. In another example, the copy module 506 may delay filling the monitoring buffer 504 by some number of entries to ensure alignment with the entries in the target waveform buffer 512. The aligning procedure may be performed for each target waveform 510 received from the circuit controller 406 or periodically through the inclusion of a peak duty cycle into the target waveform buffer 512. In this manner, the signal shaping generator 500 may ensure that the various buffers within the system remain aligned during the control of the duty cycles of the PWM signals.

FIG. 5B is a detailed block diagram of a shaping signal system 500′ that includes modules and components similar to those discussed with respect to FIGS. 4 and 5A. In system 500′, measurement signal 508 from battery 404 is received by ADC 408. Time shifted data is generated at block 506. In some embodiments, block 506 may include a copy module and/or an aligning module. Time shifted data is provided to monitoring buffer 504 which provides the time-shifted measurement signal to duty cycle module 514. Duty cycle module 514 also receives a target waveform 510 (e.g., as selected by battery recipe 511) via target waveform buffer 512. A difference between the target waveform 510 and the time shifted measurement signal is determined at adder 513 and the resulting error signal adjusted by gain 515 before entering adder 517. A prior PWM signal (i.e., PWM (n-1) is also received by the adder 517 via PWM buffer 519 and an adjusted PWM signal (i.e., PWMn) is output from the duty cycle module 514 to be stored in duty cycle buffer 516. One of skill in the art will appreciate that a PWM (n-1) may not be available on a first run of the system 500′ and an initialization module 522 may provide a selected initial PWM value. Updated PWMn data is provided to PWM controller 518 which generates control signals 520 for a plurality of switching elements within a signal shaping circuit 521. Output signal (e.g., a shaped charging and/or heating signal) from the signal shaping circuit 521 is provided to the battery 404. Additionally, the output signal may be fed to ADC 408 (illustrated separately but may be the same ADC as previously discussed) to determine an average voltage. This information may be provided as input to the battery recipe 511 and may be used in determining a subsequent target waveform 510.

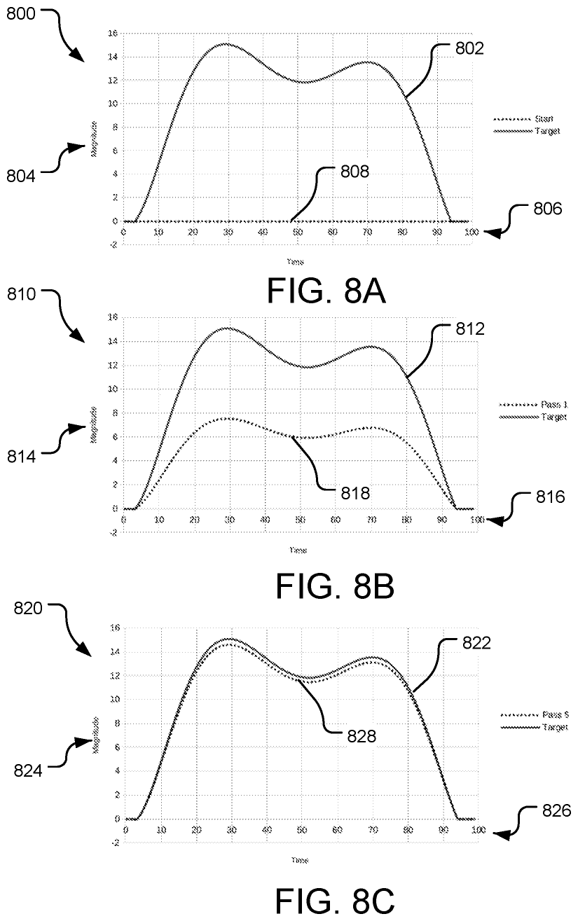

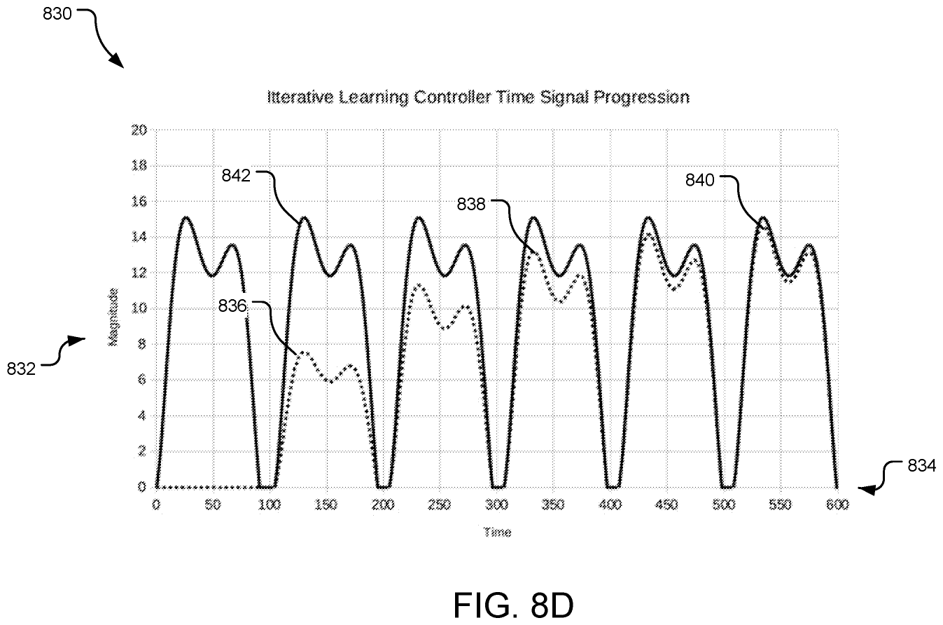

FIGS. 8A-8D are signal graphs generated from a charge signal controller through altering of a duty cycle of a pulse-width modulated signal in accordance with one embodiment. For example, the signal shaping generator 410 or other component or system discussed above may perform one or more of the operations discussed herein to shape a charge signal, particularly through the circuit 500 of FIG. 5A. As illustrated in signal graph 800 of FIG. 8A, the signal shaping generator 410 may determine a target charge signal shape, illustrated as solid line 802 of the graph. As discussed above, the target charge signal shape 802 may be any shaped (e.g., curved, oscillating, sinusoidal, linear, linear piece-wise approximations of curves, steps, ramps, and/or portions or combinations thereof) battery cell charging signal for charging a battery cell 204. The signal diagram 800 of FIG. 8A illustrates a charge signal 802 graphed as input current 804 versus time 806. In one instance, the shape of the charge signal 802 may be based on characteristics of the battery cell 204, such as a minimum real impedance value of the battery cell, or any other characteristic of the battery cell.

In addition to a target charge signal 802, an initial charge signal 808 is also included in the signal graph 800. In this particular example, the initial charge signal 808 (represented by the dotted line in the graph 800) has no magnitude, which may coincide with a starting point for charging the battery cell 204. It should be appreciated, however, that the initial charge signal 808 may be any shaped charge signal. For example, the charge circuits discussed herein may charge the battery cell 204 using a first shaped charge signal. At some later time, the target charge signal may be adjusted, such as in response to changes in the characteristics of the battery cell 204. In such circumstances, the charge signals may be altered from the initial shape to the new target shape. In this manner, a charge signal for a battery cell 204 may be shaped from any previous charge signal, including starting from no charge signal or altering an initial charge signal shape to a new charge signal shape.

As also discussed above, the method 600 for shaping a charge signal may be performed iteratively to approximate the target charge signal, approaching the target charge signal shape with each iteration of the method. For example, signal graph 810 of FIG. 8B illustrates a shaped charge signal 818 after one iteration of the above methods to shape a charge signal in response to a target charge signal 812. The target charge signal 812 and the shaped charge signal 818 are both graphed as input current 814 versus time 816. The shaped charge signal 818 illustrates the difference in the charge signal from the initial charge signal (line 808 of graph 800) after the application of the above methods to the initial charge signal. As shown, although the charge signal 818 is not exactly that of the target signal shape 812, the signal shaping generator 410 begins to approximate the shape of the target signal as a determined error between the target charge signal and applied shaped charge signal is reduced. Thus, the shaping of the charge signal begins to take on the shape of the target signal 812, with each iteration of the shaping process providing a better approximation of the target signal shape.

For example, FIG. 8C illustrates the shape of the charge signal 828 after five iterations of the processes discussed herein. As can be seen in graph 820, the shaped charge signal 828 closely approximates the target charge signal shape 822, as graphed as input current 824 versus time 826. As can be seen through the progression of the shaped charge signal 808, 818, 828 through graphs 800, 810, 820, respectively, the charge signal may be shaped to approximate the target charge signal through a series of iterations of the charge shaping method discussed herein.

Another example of the shaping of the charge signal over time is illustrated in the graph 830 of FIG. 8D. In this graph 830, a shaped charge signal is illustrated graphed as input current 832 versus time 834 as compared to the target charge signal shape 842. As illustrated, the shaped charge signal may optionally begin as a zero current input (i.e., from time 1-100) as described with respect to FIG. 8A. Subsequently, the charge signal may begin to approximate a target charge signal shape (as illustrated starting with cycle 836). Each subsequent iteration of the above method may shape the charge signal closer to a target shape 842, as illustrated through the progression to cycle 838 (illustrating the third iteration of the method) and cycle 840 (illustrating the fifth iteration of the method). The charge signal may closely approximate the target charge signal shape by cycle 840. However, although discussed as closely matching the target charge signal shape by the fifth iteration, it should be appreciated that any number of iterations of the methods discussed herein may be executed to shape the charge signal to approximate the target charge signal shape. In some embodiments, weighting of the error correction between target charge signal and applied charge signal may affect how quickly error between the two signals is minimized to a value below a predetermined threshold.

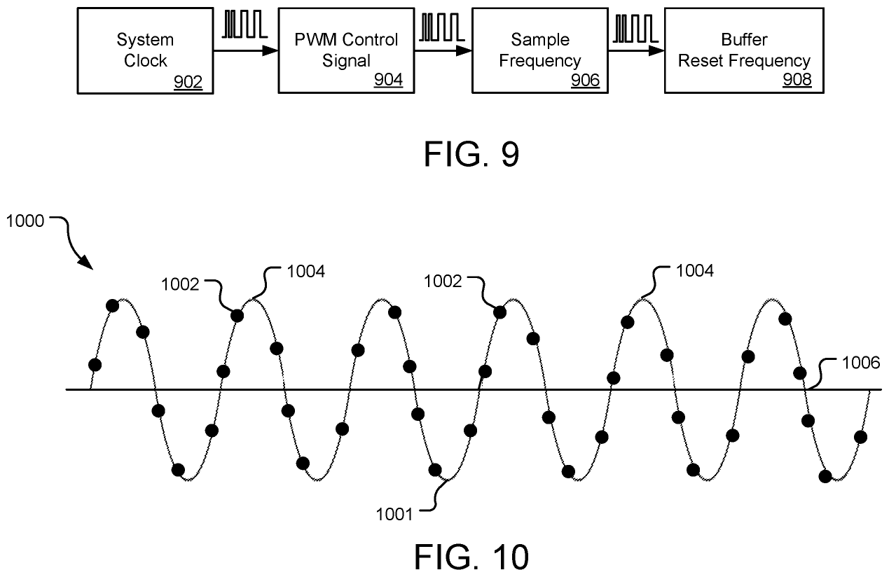

In many instances, the components of the circuit 500 of FIG. 5 may operate on clock signals of different frequencies, such that the various components may be considered to operate in different clock domains. One example of the various clock domains of the circuit 500 is illustrated in FIG. 9. As shown, the circuit may include a system clock signal 902 from which the other clock signals or domains of the circuit are derived. In some particular examples, the system clock 902 may operate at 48 MegaHertz (MHz), 170 MHz, or 5.44 GigaHertz (GHz), although other frequencies of the system clock 1002 are contemplated. The system clock signal 902 may be provided to the PWM controller 518 and used to generate the PWM control signal 520, 904. For example, the PWM control signal 904 may operate at a 1 MHz frequency through a step-down of the clock signal 902. Although described herein as having a 1 MHz frequency, the PWM control signal 904 may include any frequency derived from the system clock signal 902.

The frequency of the PWM control signal 904 may be further reduced to generate the sample frequency 906. In general, the sample frequency 906 is the frequency at which battery cell 404 is sampled, the value of which is provided to the copy module 506 in the measurement signal 508. Thus, the sample frequency 906 includes the rate at which the measurement values of the battery cell 404 may arrive at the copy module 506. In one particular implementation, the sample frequency 906 may be 100 KiloHertz (kHz). In some instances, the sample rate may be the same as or similar to the frequency at which the circuit 500 advances through the various buffers. For example, the monitoring buffer 504, the target waveform buffer 512, and/or the duty cycle buffer 516 may store a new value and release a stored value at the same rate of the sample frequency 906, such as 100 KHz. This may ensure that the monitoring buffer 504 receives the newest sample value from the measurement signal 508 at the same rate as the progression of values through the other buffers and that the buffers proceed at the same rate. Similarly, a buffer reset frequency 908 at which the buffers of the circuit 500 reset to the first entry in the respective buffers. In one instance, the buffer reset frequency 908 is 100 Hz. Thus, in this example, the buffers of the circuit 500 may include 900 entries such that, at a progression rate of 100 kHz, the buffer resets to the first entry at a frequency of 100 Hz. In some instances, the buffers may be sized and progressed such that one full wavelength of the target waveform 510 is contained within the target waveform buffer 512 and each of the buffers reset at the beginning of each new wavelength of the target waveform. In other words, the wavelength of the target waveform 510 may be the same as the buffer reset frequency 908.

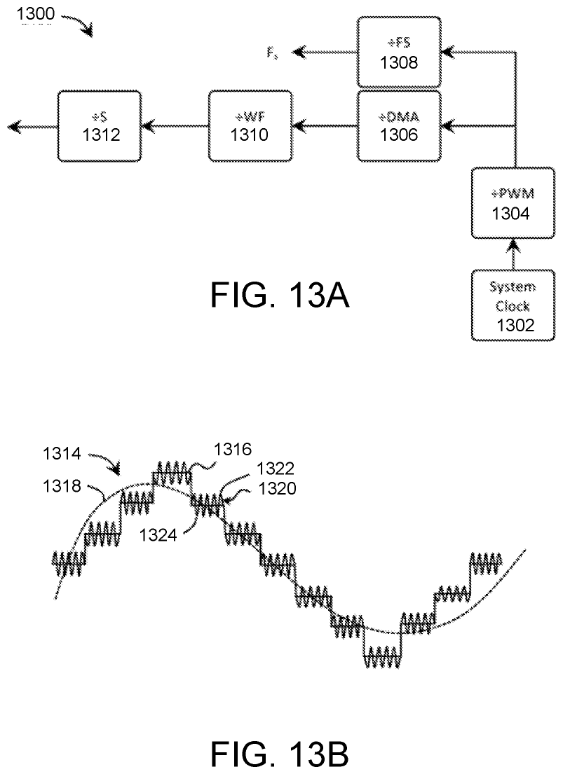

In some embodiments, the PWM control signal 520 generated by the PWM controller 518 may generate a complex charge waveform that modulates the output of the switching devices 412, 414 onto a carrier signal, where the carrier signal may take the shape of a sine wave. An example of the complex waveform is illustrated in FIG. 13B and is described in further detail below. The carrier signal may also have a frequency that is different than the PWM control signal 904 and/or the sample frequency 906. However, the frequencies of the waveforms that compose the modulated waveform may not always have a linear relationship to the frequency of the carrier signal or the sampling frequency as the PWM control signal 520 may vary in frequency over time. Due to this non-linear relationship of the sampling frequency to the complex waveform frequencies, a number of samples of the battery cell 404 obtained during each waveform period may not be exact integer multiples and, in some cases, may be irrational numbers. For example, FIG. 10 illustrates a sine wave carrier signal 1000 that may be used with the circuits and systems described above. As should be understood, the carrier wave may include a first frequency. In addition, a sample of the battery cell 404 may be obtained, illustrated at points 1002 superimposed on the illustrated carrier wave 1000. As should be appreciated, the sampling rate and the frequency of the carrier wave are not linear such that the sampling occurs at various times during the carrier wave. In many instances, it is important that the sampling rate coincides with the maxima 1004, minima 1001, and/or zero crossing 1006 of the carrier signal as the highest points of interest of the effect of the carrier wave on the battery cell 404. However, for a sampling frequency that is not linearly related to the carrier signal frequency, no samples may be obtained at these important points on the signal. In response, many systems adjust the sampling frequency to have a linear relationship with carrier signal or to the modulated waveform to ensure that a sample is obtained that includes at least one of the maxima 1004, minima 1001, and/or zero crossing 1006 of the carrier signal. However, such circuitry and implementation is often costly and requires additional computational expenses.

A lower-cost solution to addressing the difference between the sampling frequency and the complex waveform frequencies to ensure a sampling at a maxima, minima, and/or zero crossing of the carrier signal is provided below. In the approaches discussed, the sampling frequency and the carrier frequency may remain unchanged, removing the expense associated with the additional circuitry and/or programming needed to alter the sampling frequency (or other aspect of the complex waveform). In a first implementation, the circuit controller 406 may calculate or otherwise determine, in real time, a number of periods of the carrier waveform that can be stored in the target waveform buffer 512 with a set size in which a sample is obtained at the zero crossing 1006 of the carrier waveform. In one implementation, the circuit controller 406 or other computing device may determine a period of the carrier wave in which additional samples per waveform period may be available through the following calculations:

$$n = \frac{f ( waveform )}{f ( sampling )}$$

$$n ∈ \{ 0 … Ns \}$$

$${n}^{′} = n + err$$

$$Ns is the number of samples per second$$

$$m = n if err < 1 , m = n + 1 if err > 1$$

$$I ( reconstructed ) = f ( duty\_cycle , m , {I}_{feedback} ) ∀ {n}^{′}$$

Once the period of the carrier wave in which additional samples may be available is determined, the pulse train of the complex waveform may be adjusted or modified to lie within integer multiples of sampling periods, even when the actual sample numbers may change.

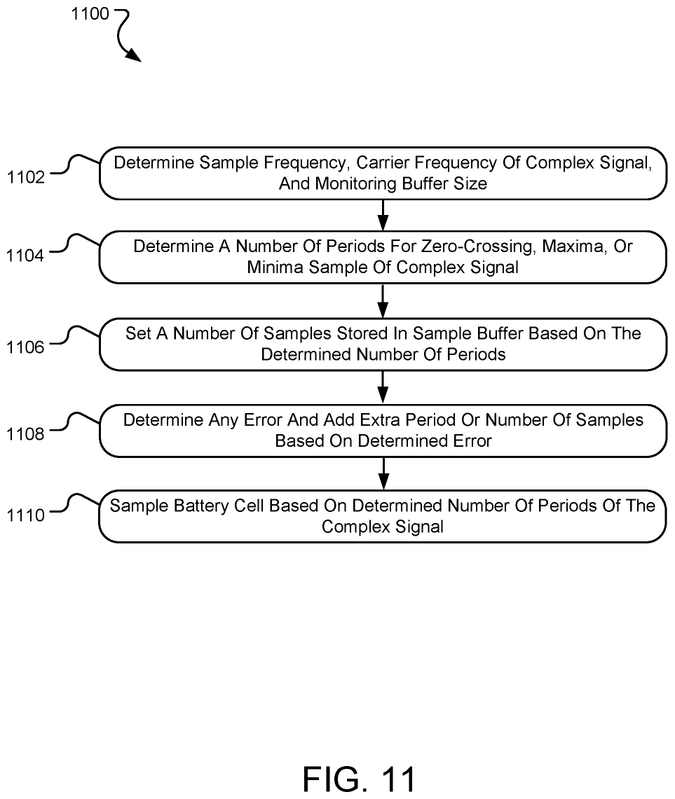

In one particular implementation, a look-up table may be generated and stored in a database associated with or in communication with the circuit controller 406 to reduce the amount of computation of the controller and increase the speed for implementing the above technique. FIG. 11 illustrates a method 1100 for utilizing a look-up table for a number of periods of a complex waveform at a given sample frequency to ensure sampling at a maxima, minima, and/or zero crossing of the carrier signal. The operations of the method 1100 may be performed or executed by the circuit controller 406 or another computing device associated with the charge system 400. In operation 1102, the sample frequency and the carrier frequency of the complex charge signal may be determined. In one example, the carrier frequency may be 8 KHz and the sample frequency may be 10 KHz. However, the techniques described herein may be utilized for any carrier frequency and/or sample frequency and the values discussed herein are for illustrative purposes only. The carrier frequency and the sample frequency may be set by the circuit controller 406 based on one or more aspects of the charge system 400, such as the time domains of the various components, a system clock signal, or any other aspect of the circuit. In addition, a size of the monitoring buffer 504 may be determined. The buffer size refers to the number of entries or measurements that can be stored in the buffer before the buffer is full. In one particular example, the monitoring buffer size may be 1000 entries such that the monitoring buffer 504 may store 1000 sample values before returning to the beginning of the buffer.

At operation 1104, a number of periods of the complex signal needed to obtain a zero crossing sample, maxima sample, or minima sample may be determined. In one implementation, the equations discussed above may be utilized to determine the number of periods of the complex signal. Continuing the above example with a carrier frequency may be 8 KHz and the sample frequency may be 10 kHz, it may be determined that 80 periods are needed to obtain a zero crossing sample. A higher carrier frequency may, however, require a higher number of periods of the complex signal, while a lower carrier frequency may require a lower number of periods of the complex signal. At operation 1106, a number of samples stored in the monitoring buffer 504 may be determined based on the number of periods determined above. Continuing the above example, samples for 80 periods of the complex signal may be obtained and stored in the monitoring buffer 504 based on the frequency of the carrier signal and the sampling rate. In general, however, the determined number of periods of the complex signal may be so as to fill the buffer as much as possible while maintaining the zero crossing sample. For example, 1000 samples may be stored in the buffer for a carrier frequency of 8 kHz and a sample frequency may be 10 kHz, while 969 samples may be stored in the buffer for a carrier frequency of 7 kHz and a sample frequency may be 10 KHz. By selecting a number of samples for storing in the buffer as close to the capacity of the buffer as possible, an efficiency of the buffer use may be maintained without adjusting the carrier frequency or the sampling rate. As should be appreciated, fewer number of total periods of the signal may be captured at lower carrier frequencies compared to higher frequency carrier signals.

In some instances, an error or remainder from the above may be determined and additional samples and/or periods of the complex signal may be obtained and stored in the buffer at operation 1208. For example, because the relationship between the carrier signal and the sampling rate may not be linear, additional space within the buffer may be present following the storing of the determined number of samples above. In such a case, the remaining buffer space may store additional samples to provide further sample data to the circuit 500. The circuit controller 406 may, in turn, be configured to consider the additional samples of the buffer while maintaining the determined number of samples for the zero crossing sample. In addition, the non-linear relationship may provide a carrier frequency that is some percentage off from the intended carrier frequency. For example, a 7 kHz carrier signal may, due to the 969 samples to achieve the zero crossing sample and the inclusion of any additional samples, may generate a carrier signal with a ˜7017 Hz frequency. However, the percent error between the intended 7000 Hz carrier signal and the 7017 Hz carrier signal is small enough that the non-linear relationship between the signals may be maintained. In some examples, this percent error between the intended carrier signal frequency and actual carrier signal frequency may be monitored. For percentage errors that exceed a threshold value, such as 5% or more, the carrier signal and/or sample rate may be discarded and a new configuration of the signals may be determined.

At operation 1110, the complex signal for charging the battery cell 404 may be generated by the circuit controller 406 and/or the signal shaping generator 410 and used to control the charging of the battery cell. In addition, sampling of the battery cell 404 by the battery cell measurement circuit 408 may be controlled based on the number of samples determined in step 1108. For example, the number of stored samples received from the battery cell measurement circuit 408 may correspond to the determined number of samples to obtain a zero crossing sample. Other points of interest for sampling may also be identified and may serve as a basis for determining a number of samples needed. Additional samples may also be stored in the monitoring buffer 504 based on the determined error discussed above. In any event, the storing of the sampling of the battery cell 404 may be based on a non-linear relationship between the complex waveform frequencies and the sampling rate.

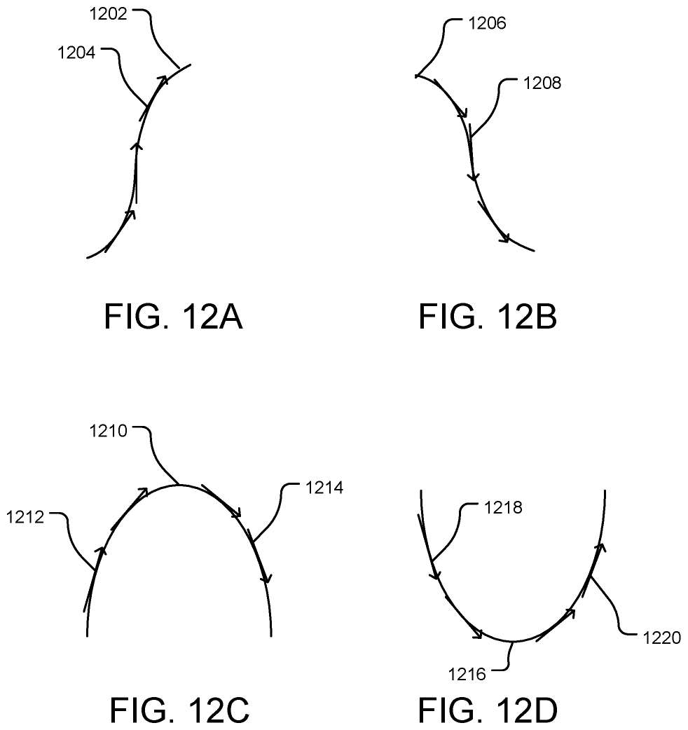

In another embodiment for providing a non-linear relationship between the complex waveform frequencies and the sampling rate may use derivatives of the complex waveform to determine a positive or negative slope to control the shape of the reconstructed complex waveform. In general, a derivative of the waveform may be used to obtain a vector direction estimate of the waveform and used to interpolate a maxima, minima, and/or zero crossings of the waveform. For example, FIG. 12A illustrates a rising edge 1302 of the complex waveform and FIG. 12B illustrates a falling edge 1206 of the waveform. The circuit controller 406 of the charging system 400 may determine one or more derivatives of the slope of the waveform to calculate a vector 1204 of the slope and, based on a comparison of subsequent vectors, estimate an upward slope or a downward slope of the waveform. For example, multiple positive, consecutive vectors 1204 may be determined by taking derivatives of the waveform. Consecutive positive vectors may suggest an upward slope of the waveform 1202, such as that illustrated in FIG. 12A. Conversely, consecutive negative vectors 1208 may suggest a downward slope of the waveform 1206, such as that illustrated in FIG. 12B. Through an analysis of positive or negative vectors of the waveform, the circuit controller 406 may determine an upward slope or downward slope of the waveform.

Such monitoring of the orientation of the derivative vectors of the waveform may continue until a transition from a positive vector to a negative vector, or vice versa, is determined. For example, FIG. 12C illustrates a positive peak 1210 of the waveform. Through the derivative of the waveform shape, a series of positive vectors 1212 may be followed by a series of negative vectors 1214 such that the circuit controller 406 may determine that a maxima, or positive peak 1210, of the waveform has occurred between the positive vectors and the negative vectors. FIG. 12D illustrates a negative peak 1216 of the waveform. Similar to above, a series of negative vectors 1218 may be followed by a series of positive vectors 1220 such that the circuit controller 406 may determine that a minima, or negative peak 1216, of the waveform has occurred between the negative vectors and the positive vectors.

An estimated peak current of the charge signal may be determined from the derivative vectors determined above and, in some instances, utilized to construct or alter the charge signal. For example, the transition from a positive vector 1212 to a negative vector 1214 indicates that a maxima peak has occurred at some point between the vectors, such as illustrated in FIG. 12C. An extrapolation technique may be applied to the charge signal based on the positive vector and the negative vector to estimate a point on the charge signal 1210 at which the maxima, or peak, occurred between the two vectors. A maximum current value may then be determined or estimated from the estimated peak. In a similar manner, a minima peak 1216 of the charge signal may also be determined or estimated. In particular, the transition from a negative vector 1218 to a positive vector 1220 indicates that a minima peak has occurred at some point between the vectors, such as illustrated in FIG. 12D. The extrapolation technique may be applied to the charge signal based on the transition to estimate a point on the charge signal 1216 at which the minima occurred between the two vectors and/or a minimum current value of the charge signal.

The charge signal may further be altered based on the estimated maxima and/or minima of the charge signal determined above. For example, once a maximum current value of the charge signal is determined, the circuit controller 406 or signal shaping generator 410 may raise or lower the maximum current of the charge signal to provide more or less charge to the battery cell 404 (as determined by the generated target waveform 510). More particularly, the duty cycle of the charge signal may be adjusted to shape the charge signal in response to the estimated maximum current value determined through the vectors. Similarly, the duty cycle of the charge signal may be adjusted in response to an estimated minimum current provided to the battery cell from the charge signal. In general, the charge signal may be altered in any manner in response to estimating the maxima or minima portions of the charge signal such that the charge signal may be a function of the slope of the waveform and the amplitude of the signal.

FIG. 13A shows a block diagram 1300 describing sampling rates and clock relationships from the switched waveform generation to the movement of data through direct memory access (DMA) and sampling of the data through an analog-to-digital converter (ADC). The switching frequency may be approximately one order of magnitude higher than the sampling frequency such that the switching frequency is significantly greater than the sampling frequency, and the sampling frequency is significantly greater than the waveform frequency. A clocking scheme is important for synchronizing and defining frequency and phase relationships across different operations within a circuit. The clocking scheme may be based on hardware capabilities and may serve as a foundation for synchronizing other aspects of wave generation and/or control systems.

The scheme 1300 includes a system clock 1302 that provides input to a PWM divider (=PWM) 1304. The PWM divider 1304 receives the clock input and divides it to achieve a selected PWM frequency. In some embodiments, the PWM frequency is selected based on a pulse output circuit (e.g., a half-bridge output circuit). The PWM frequency may be selected to balance detrimental effects associated with high and low frequencies (e.g., switching losses that increase with high frequencies and ripple effects that increase with low frequencies). The PWM divider 1304 provides input to the direct memory access (DMA) divider (=DMA) 1306 and to sample rate divider (÷FS) 1308. The sample rate divider may further divide the PWM input to obtain a sampling frequency. The DMA divider further divides the PWM frequency to achieve a selected DMA frequency suitable for a DMA controller (not shown). Output from DMA divider 1306 is provided to a waveform divider (=WF) 1310 which sets the number of samples per waveform. The number of samples per waveform may correlate to the number of samples in a target waveform buffer and/or other buffers included in the system. Finally, the number of samples per waveform is provided as input to a system supervisor clock (+s) 1312 which synchronizes the memory buffer-to-peripheral (e.g., PWM and ADC) and memory buffer-to-memory buffer transactions. In some embodiments, the DMA clock aligns with the FS (ADC sample).

FIG. 13B shows an example output signal 1314 which may be generated using the clocking scheme 1300 and a charging circuit such as system 400 illustrated in FIG. 4. The output signal 1314 may be a complex waveform where the average current magnitude (e.g., as represented by a horizontal line) for each step 1316 is the result of an oscillating pattern 1320. For each step, the pattern 1320 has a high current value 1322 and a low current value 1324 that bound the oscillations therein. Different steps may have different high and low current values to achieve a desired average current over the step duration. The steps may be controlled such that the average current (e.g., as illustrated in the zoomed-out representation of FIG. 13B) approximates a high frequency carrier waveform 1318, or a portion thereof. In general, the high current value (e.g., high current value 1322) of the pattern 1320 corresponds with a power supply (e.g., power supply 402 of FIG. 4) being connected to a battery (e.g., battery 404 of FIG. 4) via a first switching element (e.g., switching element 412 of FIG. 4) while the low current value 1324 of the oscillating pattern corresponds with a power supply being disconnected from the battery and connected to ground via a second switching element (e.g., switching element 414 of FIG. 4). The magnitude of the high and low points within the oscillating pattern may be determined by duty cycles of the first and second switching elements that control delivery of current from the power supply to the battery. Notably, the output signal 1314 produced by the clocking scheme 1300 may include some amount of error between the target carrier waveform 1318 and the steps that approximate it.

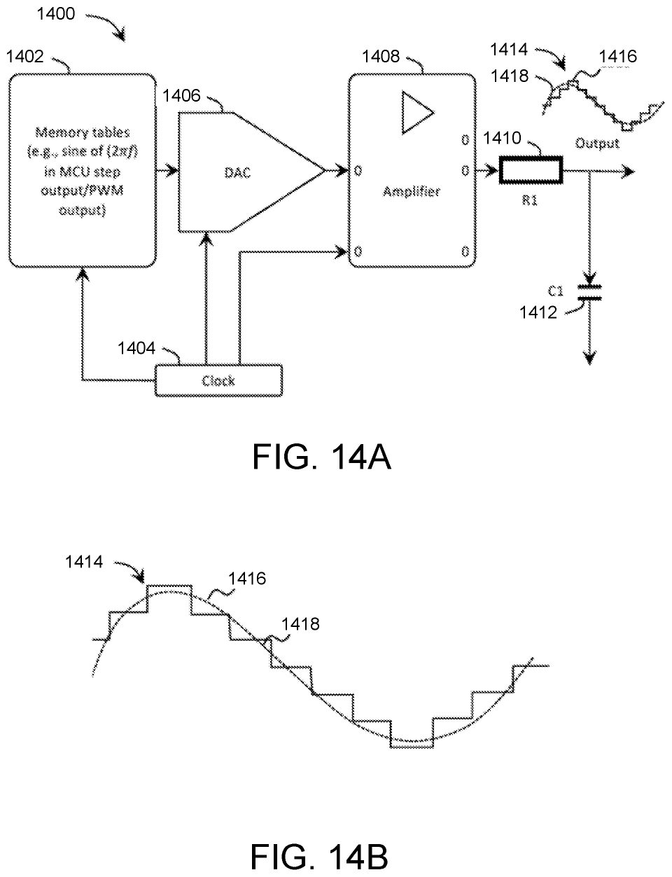

FIG. 14A is a block diagram of a waveform generator circuit 1400 that operates as a class D amplifier (i.e., an amplifier that takes an analog input signal and converts it to a PWM signal using transistors as switches). The circuit 1400 includes memory tables 1402 which may store microcontroller unit (MCU) step outputs, pulse width modulator (PWM) outputs, equations (e.g., sin (2xf)), and/or different or additional data. In some embodiments, the memory table stores MCU step outputs and/or PWM outputs or instructions. This stored data may be correlated to or may be a function of a selected carrier wave frequency, where the carrier wave is described by a frequency-based equation. The memory table receives input from a clock 1404. A digital to analog converter (DAC) 1406 receives information from the memory tables 1402 and from clock 1404. The DAC provides an output signal to amplifier 1408 and the amplifier also receives an input from clock 1404. In some embodiments, the DAC is controlled to provide a charge pulse waveform as an input to the control loop rather than providing a PWM-based DC current control. In such an embodiment, a lower resolution clock may be used to decrease component costs. In some embodiments, the amplifier 1408 may be an operational amplifier (“op-amp”) and may compare the DAC output signal (e.g., a target charging signal) to an actual current measured at the battery and provided as feedback to the amplifier.

The amplifier 1408 generates an output signal that may be received by resistive element 1410 having a resistance represented by R1. In some embodiments, the amplifier 1408 acts as a half bridge; in other embodiments, an additional half bridge component (not shown) is included between the amplifier 1408 and a resistive element 1410. An output signal 1414 from resistive element 1410 includes a plurality of steps 1416 that follow or approximate a carrier waveform 1418, which may be a high frequency, oscillating waveform. The carrier waveform may be characterized by an equation (e.g., sin (2xf)) stored in the memory tables 1402 or otherwise input to the DAC 1406.

For simplicity, FIGS. 14A and 14B illustrate the discrete steps 1416 of output signal 1414 as horizontal lines at some average current magnitude; however, similar to the signal illustrated in detail in FIG. 14B, the average current magnitude of steps 1416 may be generated by an oscillating pattern (not shown). Notably, the discrete steps 1416 of output signal 1414 generated by system 1400 more closely approximate the carrier wave 1418 when compared with the steps 1416 that approximate carrier wave 1418 in the output signal 1414.

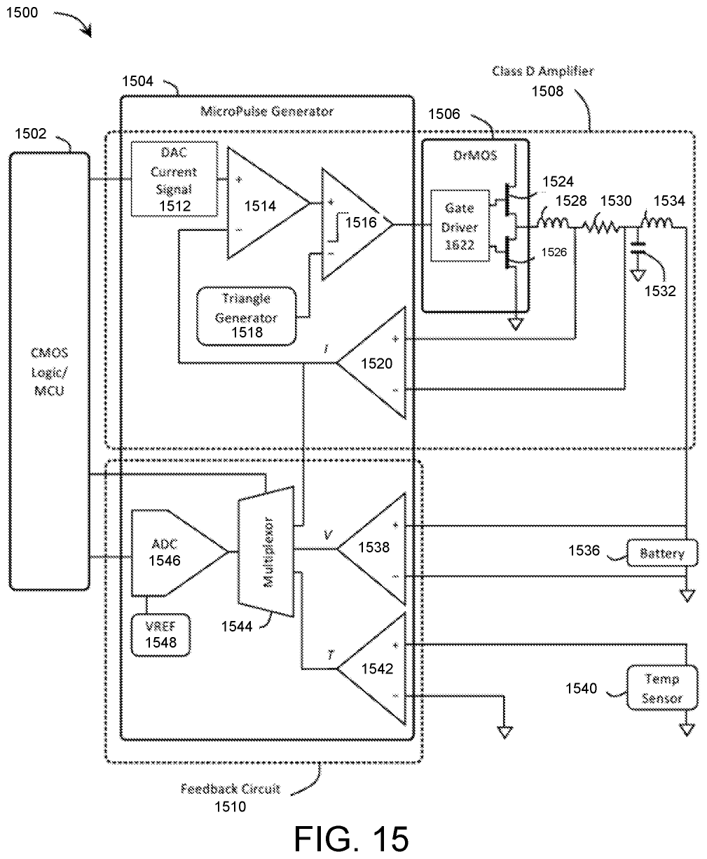

FIG. 15 is a detailed block diagram of a waveform generating system 1500. The system 1500 may generally function in the same way as system 1400 discussed above with respect to FIG. 14A and includes many of the same or similar components. The system 1500 includes a CMOS logic/MCU block 1502, a micropulse generator block 1504, and a drive metal-oxide-semiconductor field-effect transistor (DrMOS) block 1506. The micropulse generator 1504 includes components that are part of a class D amplifier 1508 and also includes components that are part of a feedback circuit 1510. The class D amplifier 1508 includes a DAC current signal 1512 configured to receive a target waveform from CMOS logic/MCU block 1502. The target waveform is provided to a first op-amp 1514 which also receives actual waveform current feedback from op-amp 1520. The difference between the target and actual waveforms is determined and provided to a comparator 1516. The comparator 1516 also receives input from a triangle generator 1518 and produces a signal for the gate driver 1522 within the DrMOS block 1506. The gate driver 1522 produces PWM control signals (e.g., one signal per switching element) for switching elements 1524, 1526. Output from the switching elements in the DrMOS block is fed through additional filtering components such as first inductor 1528, resistor 1530, capacitor 1532, and second inductor 1534. Different or additional filtering elements may be included without departing from the scope of the present disclosure. The output signal from the filtering components (e.g., a complex waveform as discussed with respect to FIG. 14B) is provided to battery cell 1536 for charging and/or heating of the cell.

Battery measurements, such as current, voltage, and temperature, may be provided to a feedback circuit 1510 as shown. The feedback circuit 1510 includes a portion of components from the micropulse generator block 1504. In particular, an op-amp 1534 may feed voltage measurement data from the battery 1536 to a multiplexor 1544 and another op-amp 1542 may feed temperature measurement data from a temperature sensor 1540 on or near the battery 1536 to the multiplexor 1544. The multiplexor may also receive current data from the op-amp 1520 and in turn may provide data back to CMOS logic/MCU block 1502. The block 1502 may use this information to update or adjust a target current signal which may then be provided to the DAC current signal 1512 in the class D amplifier block 1508.

The methods disclosed herein may be performed using any hardware that controls delivery of current using high-frequency switching. Methods described herein may advantageously reduce processing demand associated with generating a shaped charging or heating signal. Additionally, the disclosed methods may facilitate generation of a charging signal or heating signal using relatively low switching frequencies (e.g., PWM switching frequencies in a range of around 100 kHz to around 300 kHz) which may allow for lower cost componentry (e.g., PWMs, FETs, integrated circuits (ICs), etc.) to be used.

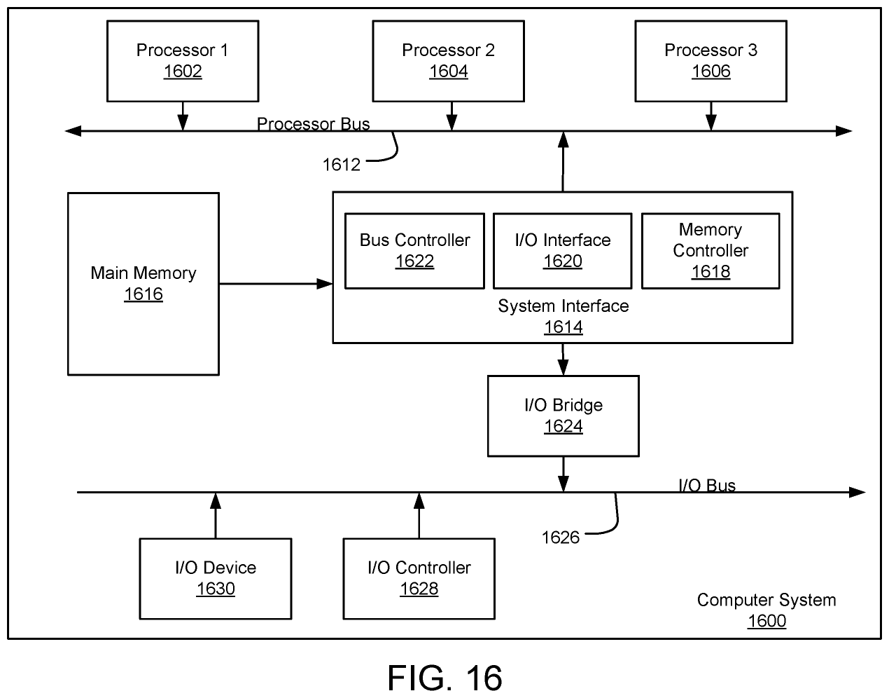

FIG. 16 is a block diagram illustrating an example of a computing device or computer system 1600 which may be used in implementing the embodiments disclosed above. In particular, the computing device of FIG. 16 is one embodiment of the circuit controller 406 that performs one or more of the operations described above. The computer system (system) includes one or more processors 1602-1606. Processors 1602-1606 may include one or more internal levels of cache (not shown) and a bus controller or bus interface unit to direct interaction with the processor bus 1612. Processor bus 1612, also known as the host bus or the front side bus, may be used to couple the processors 1602-1606 with the system interface 1614. System interface 1614 may be connected to the processor bus 1612 to interface other components of the system 1600 with the processor bus 1612. For example, system interface 1614 may include a memory controller 1618 for interfacing a main memory 1616 with the processor bus 1612. The main memory 1616 typically includes one or more memory cards and a control circuit (not shown). System interface 1614 may also include an input/output (I/O) interface 1620 to interface one or more I/O bridges or I/O devices with the processor bus 1612. One or more I/O controllers and/or I/O devices may be connected with the I/O bus 1626, such as I/O controller 1628 and I/O device 1630, as illustrated.

I/O device 1630 may also include an input device (not shown), such as an alphanumeric input device, including alphanumeric and other keys for communicating information and/or command selections to the processors 1602-1606. Another type of user input device includes cursor control, such as a mouse, a trackball, or cursor direction keys for communicating direction information and command selections to the processors 1602-1606 and for controlling cursor movement on the display device.

System 1600 may include a dynamic storage device, referred to as main memory 1616, or a random access memory (RAM) or other computer-readable devices coupled to the processor bus 1612 for storing information and instructions to be executed by the processors 1602-1606. Main memory 1616 also may be used for storing temporary variables or other intermediate information during execution of instructions by the processors 1602-1606. System 1600 may include a read only memory (ROM) and/or other static storage device coupled to the processor bus 1612 for storing static information and instructions for the processors 1602-1606. The system set forth in FIG. 16 is but one possible example of a computer system that may employ or be configured in accordance with aspects of the present disclosure.

According to one embodiment, the above techniques may be performed by computer system 1600 in response to processor 1604 executing one or more sequences of one or more instructions contained in main memory 1616. These instructions may be read into main memory 1616 from another machine-readable medium, such as a storage device. Execution of the sequences of instructions contained in main memory 1616 may cause processors 1602-1606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 1616. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

What is claimed is:

1. A method of charging an electrochemical device comprising:
modulating a pulse-width modulated (PWM) control signal onto a carrier signal for controlling a switching device;
controlling, with the modulated PWM signal, the switching device; and
iteratively adjusting, based on a frequency of the carrier signal and a predetermined sample rate, a number of samples of a measured characteristic of the electrochemical device stored in a buffer, the number of samples corresponding to obtaining a sample of the characteristic of the electrochemical device corresponding to an aspect of the modulated signal.

2. The method of claim 1, wherein the aspect of the modulated signal corresponds to a zero magnitude portion of the modulated signal.

3. The method of claim 1, wherein the aspect of the modulated signal is one of a maxima or a minima of the modulated signal.

4. The method of claim 1 further comprising:
determining one or more additional samples of the characteristic of the electrochemical device; and
storing the one or more additional samples of the characteristic of the electrochemical device in the buffer.

5. The method of claim 1 wherein a frequency of the modulated signal has a non-linear relationship to the frequency of the carrier signal.

6. The method of claim 1 further comprising:
adjusting, based on the adjusted number of samples of the characteristic of the electrochemical device stored in a buffer, a duty cycle of the PWM control signal; and
controlling the switching device with the adjusted PWM control signal.

7. The method of claim 1, wherein the switching device is of an electrochemical charging circuit further comprising an inductor, the switching device comprising a transistor controlled via the PWM control signal to produce pulses at the inductor to generate a shaped charging signal.

8. The method of claim 1, wherein the measured characteristic of the electrochemical device comprise at least one characteristic selected from a group consisting of a current, a voltage, an impedance, a resistance, and temperature.

9. A battery cell charging system comprising:
a charge signal shaping circuit modulating a pulse-width modulated (PWM) control signal onto a carrier signal for controlling a switching device; and
a controller to adjust, based on a plurality of derivatives of the modulated signal, a duty cycle of the PWM control signal of the modulated signal and control the switching device with the adjusted PWM control signal.

10. The battery cell charging system of claim 9, wherein the plurality of derivatives comprises a positive vector of the modulated signal followed by a negative vector of the modulated signal, the controller further to extrapolate a maximum of the modulated signal between the positive vector and the negative vector.

11. The battery cell charging system of claim 10, the controller to estimate a current value of the modulated signal at the extrapolated maximum of the modulated signal.

12. The battery cell charging system of claim 11, wherein the adjusting of the duty cycle of the PWM control signal is based on the estimated current value of the modulated signal at the extrapolated maximum of the modulated signal.

13. The battery cell charging system of claim 9, wherein the plurality of derivatives comprises a negative vector of the modulated signal followed by a positive vector of the modulated signal, the controller further to extrapolate a minimum of the modulated signal between the negative vector and the positive vector.

14. The battery cell charging system of claim 13, the controller further to estimate a current value of the modulated signal at the extrapolated minimum of the modulated signal.

15. The battery cell charging system of claim 14, wherein the adjusting of the duty cycle of the PWM control signal is based on the estimated current value of the modulated signal at the extrapolated minimum of the modulated signal.

16. A system for generating a signal for a battery cell, the system comprising:
a microcontroller unit (MCU) comprising a memory table, wherein the memory table contains data defining a carrier waveform and wherein the carrier waveform has a carrier waveform frequency; and
a digital-to-analog converter (DAC) in communication with the MCU and configured to receive the data defining the carrier waveform and provide an output signal to an amplifier,
wherein the amplifier comprises a plurality of switching elements configured to operate at selected switching element frequencies,
wherein the selected switching element frequencies are higher than the carrier waveform frequency, and
wherein the selected switching element frequencies are configured to produce a stepped waveform having current steps that approximate a shape of the carrier waveform.

17. The system of claim 16, wherein the amplifier is a class D amplifier.

18. The system of claim 16, further comprising a feedback module configured to measure characteristics of the battery cell and provide the measured characteristics to the MCU.

19. The system of claim 18, wherein the measured characteristics comprise at least one characteristic selected from a group consisting of current, voltage, and temperature.

20. The system of claim 19, wherein the MCU is configured to generate an updated carrier waveform based at least in part on the measured characteristics.

21. A method of charging an electrochemical device comprising:
initializing a duty cycle of a pulse-width modulated (PWM) control signal;
controlling, with a PWM control signal, a switching device of an electrochemical charging circuit; and
iteratively performing the operations of:
adjusting, based on a comparison of a measured characteristic of the electrochemical device to an expected characteristic of the electrochemical device, the initialized duty cycle of the PWM control signal; and
controlling the switching device with the adjusted PWM control signal.

22. The method of claim 21, further comprising:
storing a plurality of target waveform values in a target buffer, the plurality of target waveform values corresponding to a target charging waveform for charging the electrochemical device.

23. The method of claim 22 wherein the plurality of target waveform values comprise a plurality of expected characteristic measurements of the electrochemical device target charging waveform in response to the target charging waveform.

24. The method of claim 22 wherein adjusting the initialized duty cycle of the PWM control signal comprises:
determining a difference between the measured characteristic of the electrochemical device and at least one of the plurality of target waveform values; and
calculating a new duty cycle of the PWM control signal corresponding to the determined difference.

25. The method of claim 21 wherein initializing the duty cycle of the PWM control signal comprises storing an initial duty cycle value in a buffer, the initial duty cycle value corresponding to an initial charge current of the electrochemical device.

26. The method of claim 25 wherein the initial charge current of the electrochemical device is approximately zero amps.

27. The method of claim 25 wherein the initial charge current of the electrochemical device is based on a model of one or more parameters of the electrochemical device.

28. The method of claim 21, further comprising:
applying a weighted value to the comparison of the measured characteristic of the electrochemical device to the expected characteristic of the electrochemical device, the adjustment of the initialized duty cycle of the PWM control signal further based on the weighted value.

29. The method of claim 22, further comprising:
storing a received measurement of the characteristic of the electrochemical device; and
aligning the stored received measurement of the characteristic of the electrochemical device with an entry in the plurality of target waveform values in a target buffer.

30. The method of claim 21, further comprising:
aligning, based on a delay of the electrochemical charging circuit, an index value of a first buffer storing the measured characteristic of the electrochemical device to an index value of a second buffer storing the expected characteristic of the electrochemical device based on system delays.

31. The method of claim 21 wherein the operations are iteratively performed until the comparison of a measured characteristic of the electrochemical device to an expected characteristic of the electrochemical device is equal to or greater than a threshold error value.
